(19) United States
(12) Patent Application Publication
(10) Pub. No.: US 2014/0168278 A1
(43) Pub. Date: Jun. 19, 2014

(54) DISPLAY WITH LIGHT MODULATING PIXELS ORGANIZED IN OFF-AXIS ARRANGEMENT

(71) Applicant: PIXTRONIX, INC., San Diego, CA (US)

(72) Inventors: Jianru Shi, Haverhill, MA (US); Edward Buckley, Melrose, MA (US); Jignesh Gandhi, Burlington, MA (US)

(73) Assignee: PIXTRONIX, INC., San Diego, CA (US)

(21) Appl. No.: 13/713,158

(22) Filed: Dec. 13, 2012

(51) Int. Cl. G02B 26/02; G09G 5/10

(52) U.S. Cl. CPC G02B 26/02; G09G 5/10
USPC 345/690; 359/230; 29/592.1

(57) ABSTRACT

Displays having a plurality of shutter assemblies with movable shutters. Typically, the shutter assemblies are arranged in a grid of rows and columns, and the grid has a horizontal axis aligned with a horizontal axis of the display. The shutter assembly is aligned within the grid to have the axis of motion of respective shutters extend at an angle relative to the horizontal axis of the grid. In certain implementations, the shutter assemblies have a rectangular peripheral edge, and are arranged in the grid to have the square peripheral edge disposed at an angle relative to the horizontal axis of the grid. This can arrange the shutter assemblies into a diamond layout within the grid and place the shutter assemblies of adjacent columns into spatially offset rows of the grid. In some implementations, this increases the pixels per inch of the display, in other implementations, increases the aperture ratio.

### TECHNICAL FIELD

The field is displays, and more particularly displays with light modulating pixels that modulate light to form images.

### BACKGROUND

In a conventional digital microelectromechanical shutter (DMS) display, a plurality of microelectromechanical systems (MEMS) shutters are laid out in a grid. Each shutter is capable of blocking or passing light by moving over or away from an aperture and therefore acts as a pixel in the display. The operation of the shutters is controlled by a display controller which moves the shutters to block or pass light and thereby create an image on the display.

In this conventional design, the shutters are formed as assemblies that include the shutter, one or more electrodes for driving the shutter to open or close and other elements. These assemblies are formed on a substrate, typically an insulating material such as glass. Each assembly has a square peripheral edge and the shutter and other components of the assembly fit within the boundary of that peripheral edge. Typically, thousands of these assemblies are arranged in a two dimensional array, or grid, of rows and columns, thereby forming a display.

In operation, the shutters move over the aperture, traveling along an axis that is parallel with one of the axes of the display. When positioned over an aperture, the shutter blocks light passing through the aperture and traveling towards the surface of the display. By coding an image into data that directs certain shutters to be open and pass light and other shutters to be closed to block light, the grid of shutters can recreate the image on the display.

The ability of the display to produce an image and in particular to produce a sharply defined image turns, at least in part, on the ability of each shutter to modulate the amount of light that passes through the aperture and through the surface of the display. Specifically, the clarity of an image is improved when the shutters that are open pass light with minimal interference so that the open shutter is bright. Similarly, the clarity of an image is also improved when a shutter that is closed blocks light as fully as possible so that the closed shutter is as dark as possible. The ability to produce sharp images is enhanced when the difference in brightness between an open shutter and a closed shutter is large. It also improves the color purity and maintains the color gamut when displaying color image.

Although these displays work quite well, there remains a need to improve the sharpness and color purity of a displayed image, and in particular, there remains a need to improve the difference between the brightness of an open shutter and that of a closed shutter.

### SUMMARY

The systems and methods described herein include, among other things, displays having a plurality of shutter assemblies with movable shutters. The shutters move over and away from an aperture to modulate light passing through that aperture and thereby create images on the display. Typically, the shutter assemblies are arranged in a grid of rows and columns, and the grid has a horizontal axis that is aligned with a horizontal axis of the display. The shutter moves along an axis of motion to block or pass light from the aperture. The shutter assembly is aligned within the grid to have the axis of motion extend at an angle relative to the horizontal axis of the grid. In certain implementations, the shutter assemblies have a rectangular peripheral edge, typically a square peripheral edge, and are arranged in the grid to have the rectangular peripheral edge disposed at an angle relative to the horizontal axis of the grid. As such, the shutter assemblies can be arranged into a diamond layout within the grid and the shutter assemblies of adjacent columns can be placed into spatially offset rows of the grid. This provides a diamond layout of shutter assemblies which, in some implementations, increases the effective pixels per inch (PPI) of the display, and in some implementations increases the aperture ratio of the display. Further, in some implementations, this arrangement improves the viewing angle by improving the off-axis contrast ratio property of the display.

The shutter assemblies may be controlled by a display controller that logically groups a plurality of electromechanical shutter assemblies for controlling the grouped electromechanical shutter assemblies as sub-pixels in a logical pixel. The display controller may optionally include a grayscale controller for separately controlling the grouped electromechanical shutter assemblies to generate a grayscale value for the logical pixel. Still further, the display controller may vary the electromechanical shutter assemblies that are grouped into the logical pixel to change a location of the logical pixel within grid formed from the rows and columns of pixels. The display controller may further include a spatial grayscale controller for separately controlling electromechanical shutter assemblies adjacent the logical pixel to provide spatial grayscale.

More particularly, the systems and methods described herein include, among other things, displays having a plurality of pixels with respective electromechanical shutter assemblies arranged in rows and columns over a grid having a horizontal axis parallel to a horizontal axis of the display. The respective shutter assemblies have a shutter movable along an axis of motion, and the shutter assembly is aligned within the grid to have the axis of motion extend at an angle relative to the horizontal axis of the grid. Typically, shutter assemblies of adjacent columns of the grid are spatially offset to be arranged in different rows of the grid. Optionally, the centers of the shutter assemblies in adjacent columns are aligned along an angle substantially 45° relative to the horizontal axis. In certain implementations, a shutter assembly has a rectangular peripheral edge and a side of the edge is oriented along an angle substantially 45° angle relative to the horizontal axis of the grid.

In certain implementations, the shutter moves along the axis of motion between a first and a second position and an aperture is disposed proximate the shutter for passing light toward the shutter and wherein the first position spaces the shutter away from the aperture and the second position aligns the shutter with the aperture. The shutter may have dimensions to have the shutter in the second position align with and extend past the aperture and to overlap a peripheral edge of the aperture, wherein the shutter overlaps the peripheral edge of the aperture along the axis of motion less than or equal to axes transverse to the axis of motion.

Optionally, the display further includes a control line for controlling operation of electromechanical shutters in a column, wherein the control line connects to the shutters of a first column and to the shutters in a second column being adjacent to the first column, to connect the shutters in the first and second columns to a common control line.

In alternative implementations, the display has a common control line for controlling operation of electromechanical shutters in a column, wherein the control line connects to shutters along an axis parallel to an axis extending through center locations of the shutters.

Typically the axes of motion of shutters in adjacent columns or in adjacent rows are transverse. In some implementations, the display has an aperture for passing light toward the shutter, wherein the shutter has a rectangular peripheral edge with a side of the peripheral edge being substantially perpendicular to the axis of motion, to move along the axis of motion and across the aperture, between a first and the second position.

Optionally, the display further includes a display controller for logically grouping a plurality of electromechanical shutter assemblies and controlling the grouped electromechanical shutter assemblies as sub-pixels in a logical pixel. The display controller may include a grayscale controller for separately controlling respective ones of the grouped electromechanical shutter assemblies to generate a grayscale value for the logical pixel.

Optionally, the display controller varies the electromechanical shutter assemblies to group into the logical pixel to change a location of the logical pixel within an array formed from the rows and columns of pixels.

Further optionally, the display controller includes a spatial grayscale controller for separately controlling electromechanical shutter assemblies adjacent the logical pixel to provide spatial grayscale. In another aspect, the systems and methods descried herein include methods of manufacturing a display, which include arranging a plurality of pixels having respective electromechanical shutter assemblies in rows and columns over a grid having a horizontal axis, respective shutter assemblies having a shutter movable along an axis of motion, and arranging the pixels within the grid to align the axis of motion of a shutter in a shutter assembly to extend at an angle relative to the horizontal axis of the grid.

The method may also include spatially offsetting shutter assemblies of adjacent columns of the grid to be arranged in different rows of the grid. Arranging the pixels includes arranging the centers of shutter assemblies in adjacent columns to be aligned along an angle substantially 45° relative to the horizontal axis.

The method may also include connecting a common control line to the shutters of a first column and to the shutters in a second column adjacent to the first column or connecting shutters to a common control line extending along an axis perpendicular to the horizontal axis of the grid.

Typically, the method configures the shutter to be movable along the axis of motion between a first and a second position, and arranges the shutter assemblies within the grid to have the axes of movement of shutters in adjacent columns or rows be transverse.

Optionally, the methods provide a shutter with a rectangular peripheral edge, provide an aperture for passing light toward the shutter, and arrange a side of the peripheral edge to move substantially perpendicular to the axis of movement and across the aperture to substantially block light passed toward the shutter.

In some implementations, the method provides control lines extending generally along columns of the grid, and selects a size of shutter assembly to arrange two shutter assemblies within a space defined by four adjacent control lines and selecting a size of aperture of a shutter assembly to achieve a selected aperture ratio.

In another aspect, the systems and methods described herein display a grayscale image. The methods, may provide a plurality of electromechanical shutter assemblies, arrange the shutter assemblies in rows and columns over a grid having a horizontal axis, wherein the shutter assemblies of adjacent columns are offset to align centers of shutter assemblies in adjacent columns along an angle relative to the horizontal axis, logically group a plurality of shutter assemblies, and control the grouped shutter assemblies as sub-pixels in a logical pixel to generate a grayscale illumination.

The method may include receiving a grayscale value for the logical pixel, and separately controlling respective ones of the shutter assemblies within the logical pixel according to the grayscale value for the logical pixel. It may optionally vary the shutter assemblies to group into the logical pixel to change a location of the logical pixel within an array formed from the rows and columns of pixels, and may separately control electromechanical shutters adjacent the logical pixel to provide dithered grayscale in an image.

These and other implementations may be provided by the systems and methods disclosed herein and certain illustrations, not to be treated as limiting, will be described in more detail.

### BRIEF DESCRIPTION OF THE DRAWINGS

The foregoing discussion will be understood more readily from the following detailed description with reference to the following drawings

FIG. 1A is an isometric view of an example display apparatus.

FIG. 1B is a block diagram of the display apparatus of FIG. 1A.

FIG. 2 is a perspective view of an illustrative shutter-based light modulator suitable for incorporation into the MEMS-based display of FIG. 1A.

FIG. 3A is a schematic diagram of a control matrix suitable for controlling the light modulators incorporated into the MEMS-based display of FIG. 1A.

FIG. 3B is a perspective view of an array of shutter-based light modulators connected to the control matrix of FIG. 3A.

FIGS. 4A and 4B are plan views of a dual-actuated shutter assembly in the open and closed states respectively.

FIG. 5 is a cross-sectional view of a shutter-based display apparatus.

FIGS. 6A and 6B are system block diagrams illustrating a display device that includes a plurality of light modulator display elements.

FIGS. 7A and 7B are a plan and a cross-sectional view of a shutter-based display respectively.

FIG. 8 depicts a plan view of a shutter moved away from an aperture and a shutter moved over an aperture.

FIG. 9 depicts a plan view of a display having rotated shutter assemblies.

FIG. 10 depicts an alternate implementation of a display having rotated shutter assemblies.

FIG. 11 depicts a plurality of shutter assemblies grouped as a logical pixel.

FIG. 12 depicts relative pixel pitch between a display with shutter assemblies aligned to a display and a display with shutter assemblies rotated relative to the display.

FIG. 13 depicts two arrays having similar line densities and different aperture ratios.

FIG. 14 is a plan view of an array of shutter assemblies having shutter assemblies of different sizes.

### DETAILED DESCRIPTION OF THE DRAWINGS

To provide an overall understanding of the application, certain illustrative implementations will now be described, including apparatus and methods for displaying images and in particular displays that include a plurality of shutters, arranged into an array and where at least a portion of the shutters are aligned to move along an axis that extends at an angle relative to the peripheral edges of the display. In some implementations, the shutters are arranged into a diamond layout.

Particular implementations of the subject matter described in this disclosure can be implemented to realize one or more of the following potential advantages. The systems and methods disclosed, in some implementations, may provide, among other things, displays having improved performance along viewing directions that are transverse to the edges of the display. In some implementations, the systems and methods disclosed herein may reduce noise arising from the opening and closing of the shutters. Still other advantages will be apparent to those of skill in the art.

However, it will be understood by one having ordinary skill in the art that the systems and methods described herein may be adapted and modified as is appropriate for the application being addressed and that the systems and methods described herein may be employed in other suitable applications, and that such other additions and modifications will not depart from the scope hereof.

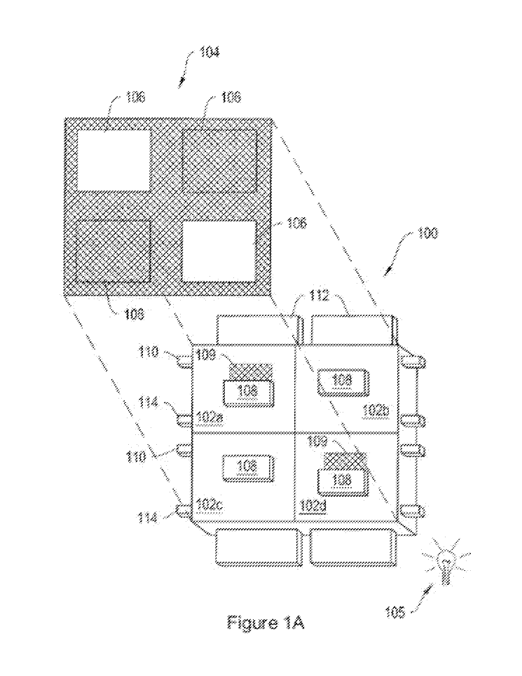

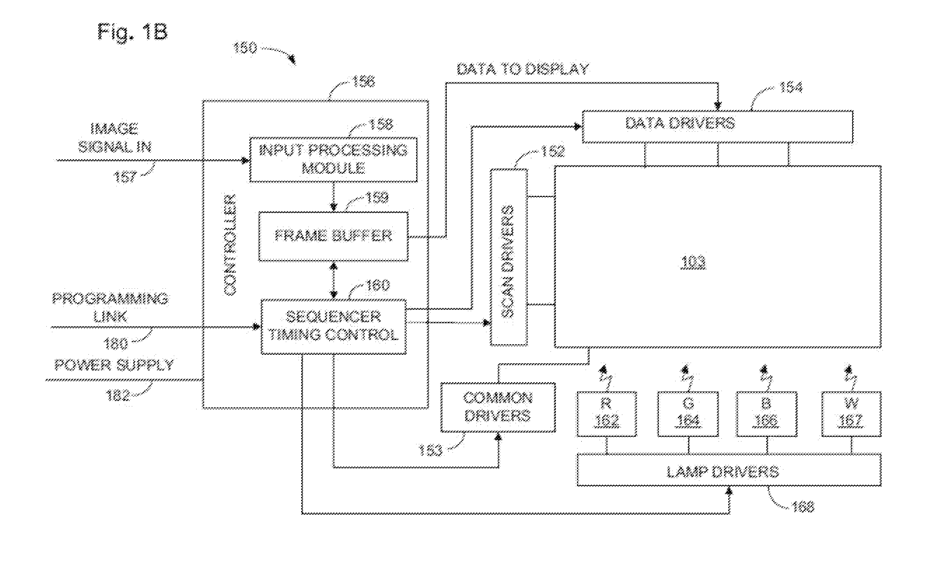

FIG. 1A is an isometric view of an example display apparatus. In particular, FIG. 1A provides a schematic diagram of a direct-view MEMS-based display apparatus 100. The display apparatus 100 includes a plurality of light modulators 102a-102d (generally “light modulators 102”) arranged in rows and columns. In the display apparatus 100, light modulators 102a and 102d are in the open state, allowing light to pass. Light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a frontlight. In one of the closed or open states, the light modulators 102 interfere with light in an optical path by, for example, and without limitation, blocking, reflecting, absorbing, filtering, polarizing, diffracting, or otherwise altering a property or path of the light.

In the display apparatus 100, each light modulator 102 corresponds to a pixel 106 in the image 104. In other implementations, the display apparatus 100 may utilize a plurality of light modulators 102 to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In this implementation using these color-specific light modulators 102, a pixel 106 in image 104 will include the three pixels 106 associated with the three light modulators 102 that produce the three colors of the color pixel 106. In another example, the display apparatus 100 includes two or more light modulators 102 per pixel 106 to provide grayscale in an image 104. With respect to an image, a “pixel” corresponds to the smallest picture element defined by the resolution of the image. With respect to structural components of the display apparatus 100, the term “pixel” refers to the combined mechanical and electrical components utilized to modulate the light that forms a single pixel of the image.

Display apparatus 100 is a direct-view display in that it does not require imaging optics. The user sees an image by looking directly at the display apparatus 100. In alternate implementations the display apparatus 100 is incorporated into a projection display. In such implementations, the display forms an image by projecting light onto a screen or onto a wall.

Direct-view displays may operate in either a transmissive or reflective mode. In a transmissive display, the light modulators filter or selectively block light which originates from a lamp or lamps positioned behind the display. The light from the lamps is optionally injected into a light guide or “backlight”. Transmissive direct-view display implementations are often built onto transparent or glass substrates to facilitate a sandwich assembly arrangement where one substrate, containing the light modulators, is positioned directly on top of the backlight. In some transmissive display implementations, a color-specific light modulator is created by associating a color filter material with each light modulator 102. In other transmissive display implementations colors can be generated, as described below, using a field sequential color method by alternating illumination of lamps with different primary colors.

Each light modulator 102 includes a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material.

The display apparatus also includes a control matrix connected to the substrate and to the light modulators for controlling the movement of the shutters. The control matrix includes a series of electrical interconnects (e.g., interconnects 110, 112, and 114), including at least one write-enable interconnect 110 (also referred to as a “scan-line interconnect”) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the “write-enabling voltage, V_{we}”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In other implementations, the data voltage pulses control switches, e.g., transistors or other non-linear circuit elements that control the application of separate actuation voltages, which are typically higher in magnitude than the data voltages, to the light modulators 102. The application of these actuation voltages then results in the electrostatic driven movement of the shutters 108, moving the shutters 108 from a first position to a second position. In certain implementations, this moves a shutter 108 from an open position to a closed position. But in other implementations, the actuation voltage may drive the shutter between first and second positions that are intermediate between open and closed.

FIG. 1B is a block diagram of the display apparatus of FIG. 1A. Referring to FIGS. 1A and 1B, in addition to the elements of the display apparatus 100 described above, as depicted in the block diagram 150, the display apparatus 100 includes a plurality of scan drivers 152 (also referred to as “write enabling voltage sources”) and a plurality of data drivers 154 (also referred to as “data voltage sources”). The scan drivers 152 apply write enabling voltages to scan-line interconnects 110. The data drivers 154 apply data voltages to the data interconnects 112. In some implementations of the display apparatus, the data drivers 154 are configured to provide analog data voltages to the light modulators, especially where the grayscale of the image 104 is to be derived in analog fashion. In analog operation the light modulators 102 are designed such that when a range of intermediate voltages is applied through the data interconnects 112 there results a range of intermediate open states in the shutters 108 and therefore a range of intermediate illumination states or grayscales in the image 104.

In other cases the data drivers 154 are configured to apply only a reduced set of 2, 3, or 4 digital voltage levels to the control matrix. These voltage levels set, in digital fashion, either an open state or a closed state to each of the shutters 108.

The scan drivers 152 and the data drivers 154 are connected to digital controller circuit 156 (also referred to as the “controller 156”). The controller 156 includes an input processing module 158, which processes an incoming image signal 157 into a digital image format appropriate to the spatial addressing and the grayscale capabilities of the display 100. The pixel location and grayscale data of each image is stored in a frame buffer 159 so that the data can be fed out as needed to the data drivers 154. The data is sent to the data drivers 154 in mostly serial fashion, organized in predetermined sequences grouped by rows and by image frames. The data drivers 154 can include series to parallel data converters, level shifting, and for some applications digital to analog voltage converters.

The display apparatus 100 optionally includes a set of common drivers 153, also referred to as common voltage sources. In some implementations the common drivers 153 provide a DC common potential to all light modulators within the array of light modulators 103, for instance by supplying voltage to a series of common interconnects 114. In other implementations the common drivers 153, following commands from the controller 156, issue voltage pulses or signals to the array of light modulators 103, for instance global actuation pulses which are capable of driving and/or initiating simultaneous actuation of all light modulators in multiple rows and columns of the array 103.

The drivers (e.g., scan drivers 152, data drivers 154, and common drivers 153) for different display functions are time-synchronized by a timing-control module 160 in the controller 156. Timing commands from the module 160 coordinate the illumination of red, green and blue and white lamps (162, 164, 166, and 167 respectively) via lamp drivers 168, the write-enabling and sequencing of specific rows within the array of pixels 103, the output of voltages from the data drivers 154, and the output of voltages that provide for light modulator actuation.

The controller 156 determines the sequencing or addressing scheme by which each of the shutters 108 in the array 103 can be re-set to the illumination levels appropriate to a new image 104. New images 104 can be set at periodic intervals. For instance, for video displays, the color images 104 or frames of video are refreshed at frequencies ranging from 10 to 300 Hertz. In some implementations, the setting of an image frame to the array 103 is synchronized with the illumination of the lamps 162, 164, and 166 such that alternate image frames are illuminated with an alternating series of colors, such as red, green, and blue. The image frames for each respective color is referred to as a color sub-frame. In this method, referred to as the field sequential color method, if the color sub-frames are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green, and blue.

In some implementations, where the display apparatus 100 is designed for the digital switching of shutters 108 between open and closed states, the controller 156 determines the addressing sequence and/or the time intervals between image frames to produce images 104 with appropriate grayscale. The process of generating varying levels of grayscale by controlling the amount of time a shutter 108 is open in a particular frame is referred to as time division grayscale. In some implementations of time division grayscale, the controller 156 determines the time period or the fraction of time within each frame that a shutter 108 is allowed to remain in the open state, according to the illumination level or grayscale desired of that pixel. In other implementations, for each image frame, the controller 156 sets a plurality of sub-frame images in multiple rows and columns of the array 103, and the controller alters the duration over which each sub-frame image is illuminated in proportion to a grayscale value or significance value employed within a coded word for grayscale. For instance, the illumination times for a series of sub-frame images can be varied in proportion to the binary coding series 1,2,4,8. The shutters 108 for each pixel in the array 103 are then set to either the open or closed state within a sub-frame image according to the value at a corresponding position within the pixel's binary coded word for gray level.

In other implementations, the controller 156 alters the intensity of light from the lamps 162, 164, and 166 in proportion to the grayscale value desired for a particular sub-frame image. A number of hybrid techniques are also available for forming colors and grayscale from an array of shutters 108. For instance, the time division techniques described above can be combined with the use of multiple shutters 108 per pixel, or the grayscale value for a particular sub-frame image can be established through a combination of both sub-frame timing and lamp intensity.

In some implementations, the data for an image state 104 is loaded by the controller 156 to the modulator array 103 by a sequential addressing of individual rows, also referred to as scan lines. For each row or scan line in the sequence, the scan driver 152 applies a write-enable voltage to the write enable interconnect 110 for that row of the array 103, and subsequently the data driver 154 supplies data voltages, corresponding to desired shutter states, for each column in the selected row. This process repeats until data has been loaded for all rows in the array. In some implementations the sequence of selected rows for data loading is linear, proceeding from top to bottom in the array. In other implementations, the sequence of selected rows is pseudo-randomized, in order to minimize visual artifacts. In further implementations, the sequencing is organized by blocks, where, for a block, the data for only a certain fraction of the image state 104 is loaded to the array, for instance by addressing only every 5^{th} row of the array in sequence.

In some implementations, the process for loading image data to the array 103 is separated in time from the process of actuating the shutters 108. In these implementations, the modulator array 103 may include data memory elements for each pixel in the array 103 and the control matrix may include a global actuation interconnect for carrying trigger signals, from common driver 153, to initiate simultaneous actuation of shutters 108 according to data stored in the memory elements. Various addressing sequences, many of which are described in U.S. patent application Ser. No. 11/643,042, can be coordinated by means of the timing control module 160.

In alternative implementations, the array of pixels 103 and the control matrix that controls the pixels may be arranged in configurations other than rectangular rows and columns. For example, the pixels can be arranged in hexagonal arrays or curvilinear rows and columns. In general, as used herein, the term scan-line shall refer to any plurality of pixels that share a write-enabling interconnect.

The display 100 includes of a plurality of functional blocks including the timing control module 160, the frame buffer 159, scan drivers 152, data drivers 154, common drivers 153 and lamp drivers 168. Each block can be understood to represent either a distinguishable hardware circuit and/or a module of executable code. In some implementations the functional blocks are provided as distinct chips or circuits connected together by means of circuit boards and/or cables. Alternately, many of these circuits can be fabricated along with the pixel array 103 on the same substrate of glass or plastic. In other implementations, multiple circuits, drivers, processors, and/or control functions from block diagram 150 may be integrated together within a single silicon chip, which is then bonded directly to the transparent substrate holding pixel array 103.

The controller 156 includes a programming link 180 by which the addressing, color, and/or grayscale algorithms, which are implemented within controller 156, can be altered according to the needs of particular applications. In some implementations, the programming link 180 conveys information from environmental sensors, such as ambient light or temperature sensors, so that the controller 156 can adjust imaging modes or backlight power in correspondence with environmental conditions. The controller 156 also includes a power supply input 182 which provides the power needed for lamps as well as light modulator actuation. Where necessary, the drivers 152, 153, 154, and/or 168 may include or be associated with DC-DC converters for transforming an input voltage at 182 into various voltages sufficient for the actuation of shutters 108 or illumination of the lamps, such as lamps 162, 164, 166, and 167.

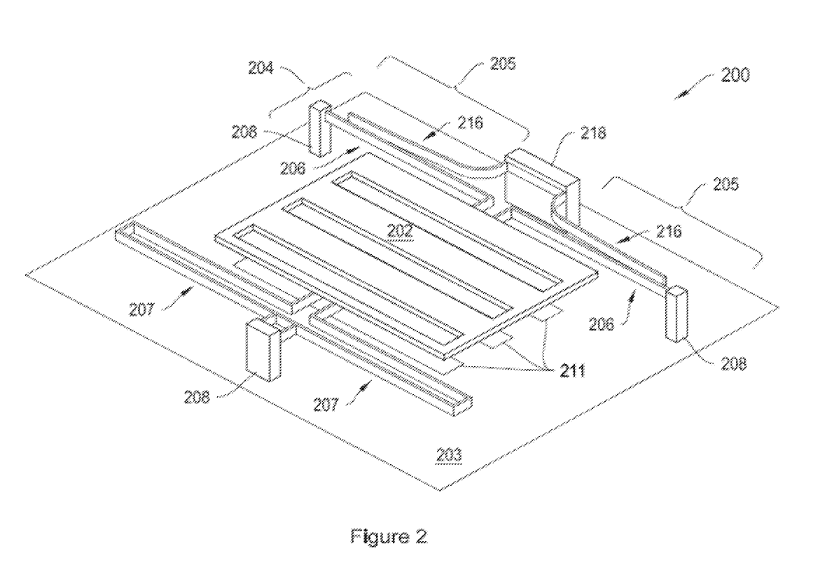

FIG. 2 is a perspective view of an illustrative shutter-based light modulator 200 suitable for incorporation into the MEMS-based display apparatus 100 of FIG. 1A. The shutter-based light modulator 200 (also referred to as shutter assembly 200) includes a shutter 202 coupled to an actuator 204. The actuator 204 is formed from two separate compliant electrode beam actuators 205 (the “actuators 205”), as described in U.S. Pat. No. 7,271,945. The shutter 202 couples on one side to the actuators 205. The actuators 205 move the shutter 202 transversely over a surface 203 in a plane of motion which is substantially parallel to the surface 203. The opposite side of the shutter 202 couples to a spring 207 which provides a restoring force opposing the forces exerted by the actuator 204.

Each actuator 205 includes a compliant load beam 206 connecting the shutter 202 to a load anchor 208. The load anchors 208 along with the compliant load beams 206 serve as mechanical supports, keeping the shutter 202 suspended proximate to the surface 203. The load anchors 208 physically connect the compliant load beams 206 and the shutter 202 to the surface 203 and electrically connect the load beams 206 to a bias voltage, in some instances, ground.

Each actuator 205 also includes a compliant drive beam 216 positioned adjacent to each load beam 206. The drive beams 216 couple at one end to a drive beam anchor 218 shared between the drive beams 216. The other end of each drive beam 216 is free to move. Each drive beam 216 is curved such that it is closest to the load beam 206 near the free end of the drive beam 216 and the anchored end of the load beam 206.

The surface 203 includes one or more apertures 211 for admitting the passage of light. If the shutter assembly 200 is formed on an opaque substrate, made for example from silicon, then the surface 203 is a surface of the substrate, and the apertures 211 are formed by etching an array of holes through the substrate. If the shutter assembly 200 is formed on a transparent substrate, made for example of glass or plastic, then the surface 203 is a surface of a light blocking layer deposited on the substrate, and the apertures are formed by etching the surface 203 into an array of holes 211. The apertures 211 can be generally circular, elliptical, polygonal, serpentine, or irregular in shape.

In operation, a display apparatus incorporating the light modulator 200 applies an electric potential to the drive beams 216 via the drive beam anchor 218. A second electric potential may be applied to the load beams 206. The resulting potential difference between the drive beams 216 and the load beams 206 pulls the free ends of the drive beams 216 towards the anchored ends of the load beams 206, and pulls the shutter ends of the load beams 206 toward the anchored ends of the drive beams 216, thereby driving the shutter 202 transversely towards the drive anchor 218. The compliant members 206 act as springs, such that when the voltage across the beams 206 and 216 is removed, the load beams 206 push the shutter 202 back into its initial position, releasing the stress stored in the load beams 206.

The shutter assembly 200, also referred to as an elastic shutter assembly, incorporates a passive restoring force, such as a spring, for returning a shutter to its rest or relaxed position after voltages have been removed. A number of elastic restore mechanisms and various electrostatic couplings can be designed into or in conjunction with electrostatic actuators, the compliant beams illustrated in shutter assembly 200 being just one example. For instance, a highly non-linear voltage-displacement response can be provided which favors an abrupt transition between “open” vs. “closed” states of operation, and which, in many cases, provides a bi-stable or hysteretic operating characteristic for the shutter assembly. Other electrostatic actuators can be designed with more incremental voltage-displacement responses and with considerably reduced hysteresis, as may be used for analog grayscale operation.

The actuator 205 within the elastic shutter assembly is said to operate between a closed or actuated position and a relaxed position. The designer, however, can choose to place apertures 211 such that shutter assembly 200 is in either the “open” state, i.e. passing light, or in the “closed” state, i.e. blocking light, whenever actuator 205 is in its relaxed position. For illustrative purposes, it is assumed below that elastic shutter assemblies described herein are designed to be open in their relaxed state.

In many cases, a dual set of “open” and “closed” actuators may be provided as part of a shutter assembly so that the control electronics are capable of electrostatically driving the shutters into each of the open and closed states.

Display apparatus 100, in alternative implementations, includes light modulators other than transverse shutter-based light modulators, such as the shutter assembly 200 described above. For example, an alternative implementation may include a rolling actuator shutter-based light modulator 220 suitable for incorporation into an alternative implementation of the MEMS-based display apparatus 100 of FIG. 1A. A rolling actuator-based light modulator includes a moveable electrode disposed opposite a fixed electrode and biased to move in a particular direction to produce a shutter upon application of an electric field. It will be understood that still other MEMS light modulators are known and can be usefully incorporated into the implementations described herein.

Similarly, other types of shutter control systems may be employed with the display described herein and a variety of methods may be used to control an array of shutters via a control matrix to produce images, in many cases moving images, with appropriate grayscale. In some cases, control is accomplished by means of a passive matrix array of row and column interconnects connected to driver circuits on the periphery of the display. In other cases it is appropriate to include switching and/or data storage elements within each pixel of the array (the so-called active matrix) to improve either the speed, the grayscale and/or the power dissipation performance of the display. Any of these control systems may be employed with the systems and methods described herein.

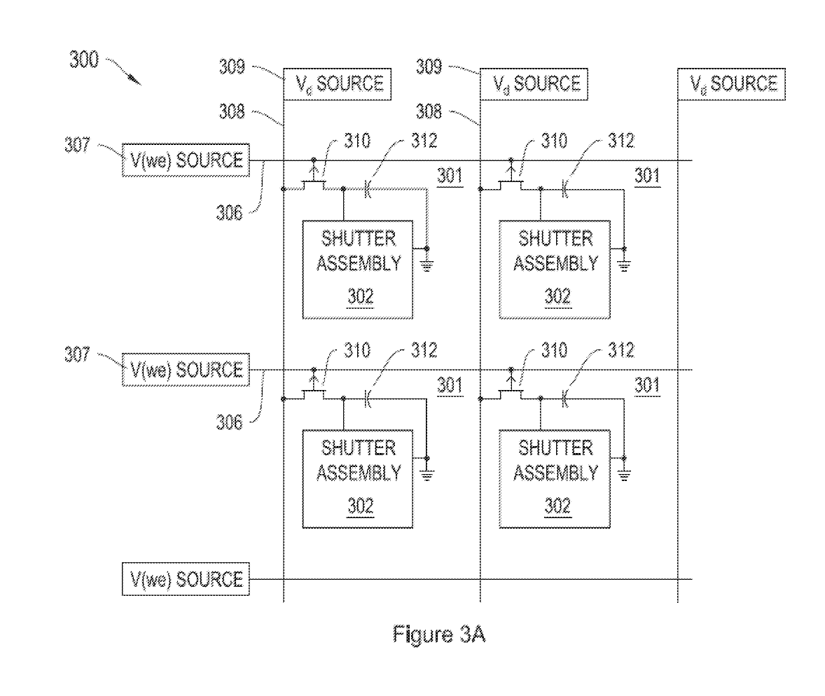

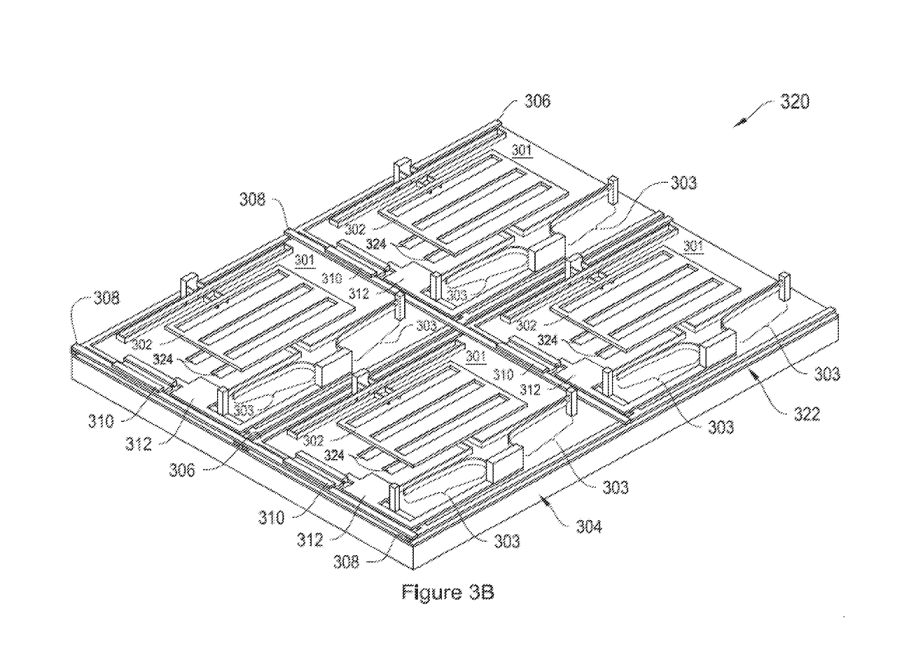

FIG. 3A is a schematic diagram of one control matrix 300 suitable for controlling the light modulators incorporated into the MEMS-based display apparatus 100 of FIG. 1A. FIG. 3B is a perspective view of an array 320 of shutter-based light modulators connected to the control matrix 300 of FIG. 3A. The control matrix 300 may address an array of pixels 320 (the “array 320”). Each pixel 301 includes an elastic shutter assembly 302, such as the shutter assembly 200 of FIG. 2A, controlled by an actuator 303. Each pixel also includes an aperture layer 322 that includes apertures 324.

The control matrix 300 may be fabricated as a diffused or thin-film-deposited electrical circuit on the surface of a substrate 304 on which the shutter assemblies 302 are formed. The control matrix 300 may include a scan-line interconnect 306 for each row of pixels 301 in the control matrix 300 and a data-interconnect 308 for each column of pixels 301 in the control matrix 300. Each scan-line interconnect 306 electrically connects a write-enabling voltage source 307 to the pixels 301 in a corresponding row of pixels 301. Each data interconnect 308 electrically connects a data voltage source, (“Vd source”) 309 to the pixels 301 in a corresponding column of pixels 301. In control matrix 300, the data voltage V_{d} provides the majority of the energy necessary for actuation of the shutter assemblies 302. Thus, the data voltage source 309 also serves as an actuation voltage source.

Referring to FIGS. 3A and 3B, for each pixel 301 or for each shutter assembly 302 in the array of pixels 320, the control matrix 300 includes a transistor 310 and a capacitor 312. The gate of each transistor 310 is electrically connected to the scan-line interconnect 306 of the row in the array 320 in which the pixel 301 is located. The source of each transistor 310 is electrically connected to its corresponding data interconnect 308. The actuators 303 of each shutter assembly 302 include two electrodes. The drain of each transistor 310 is electrically connected in parallel to one electrode of the corresponding capacitor 312 and to one of the electrodes of the corresponding actuator 303. The other electrode of the capacitor 312 and the other electrode of the actuator 303 in shutter assembly 302 are connected to a common or ground potential. In alternate implementations, the transistors 310 can be replaced with semiconductor diodes and or metal-insulator-metal sandwich type switching elements.

In operation, to form an image, the control matrix 300 write-enables each row in the array 320 in a sequence by applying V_{we} to each scan-line interconnect 306 in turn. For a write-enabled row, the application of V_{we} to the gates of the transistors 310 of the pixels 301 in the row allows the flow of current through the data interconnects 308 through the transistors 310 to apply a potential to the actuator 303 of the shutter assembly 302. While the row is write-enabled, data voltages V_{d} are selectively applied to the data interconnects 308. In implementations providing analog grayscale, the data voltage applied to each data interconnect 308 is varied in relation to the desired brightness of the pixel 301 located at the intersection of the write-enabled scan-line interconnect 306 and the data interconnect 308. In implementations providing digital control schemes, the data voltage is selected to be either a relatively low magnitude voltage (i.e., a voltage near ground) or to meet or exceed Vₐₜ (the actuation threshold voltage). In response to the application of Vₐₜ to a data interconnect 308, the actuator 303 in the corresponding shutter assembly 302 actuates, opening the shutter in that shutter assembly 302. The voltage applied to the data interconnect 308 remains stored in the capacitor 312 of the pixel 301 even after the control matrix 300 ceases to apply V_{we} to a row. It is not necessary, therefore, to wait and hold the voltage V_{we} on a row for times long enough for the shutter assembly 302 to actuate; such actuation can proceed after the write-enabling voltage has been removed from the row. The capacitors 312 also function as memory elements within the array 320, storing actuation instructions for periods as long as is necessary for the illumination of an image frame.

The pixels 301 as well as the control matrix 300 of the array 320 are formed on a substrate 304. The array includes an aperture layer 322, disposed on the substrate 304, which includes a set of apertures 324 for respective pixels 301 in the array 320. The apertures 324 are aligned with the shutter assemblies 302 in each pixel. In one implementation the substrate 304 is made of a transparent material, such as glass or plastic. In another implementation the substrate 304 is made of an opaque material, but in which holes are etched to form the apertures 324.

Components of shutter assemblies 302 are processed either at the same time as the control matrix 300 or in subsequent processing steps on the same substrate. The electrical components in control matrix 300 are fabricated using many thin film techniques in common with the manufacture of thin film transistor arrays for liquid crystal displays. The shutter assemblies are fabricated using techniques similar to the art of micromachining or from the manufacture of micromechanical (i.e., MEMS) devices. For instance, the shutter assembly 302 can be formed from thin films of amorphous silicon, deposited by a chemical vapor deposition process.

The shutter assembly 302 together with the actuator 303 can be made bi-stable. That is, the shutters can exist in at least two equilibrium positions (e.g. open or closed) with little or no power required to hold them in either position. More particularly, the shutter assembly 302 can be mechanically bi-stable. Once the shutter of the shutter assembly 302 is set in position, no electrical energy or holding voltage is required to maintain that position. The mechanical stresses on the physical elements of the shutter assembly 302 can hold the shutter in place.

The shutter assembly 302 together with the actuator 303 can also be made electrically bi-stable. In an electrically bi-stable shutter assembly, there exists a range of voltages below the actuation voltage of the shutter assembly, which if applied to a closed actuator (with the shutter being either open or closed), holds the actuator closed and the shutter in position, even if an opposing force is exerted on the shutter. The opposing force may be exerted by a spring such as spring 207 in shutter-based light modulator 200, or the opposing force may be exerted by an opposing actuator, such as an “open” or “closed” actuator.

The light modulator array 320 is depicted as having a single MEMS light modulator per pixel. Other implementations are possible in which multiple MEMS light modulators are provided in each pixel, thereby providing the possibility of more than just binary “on” or “off” optical states in each pixel. Certain forms of coded area division grayscale are possible where multiple MEMS light modulators in the pixel are provided, and where apertures 324, which are associated with each of the light modulators, have unequal areas.

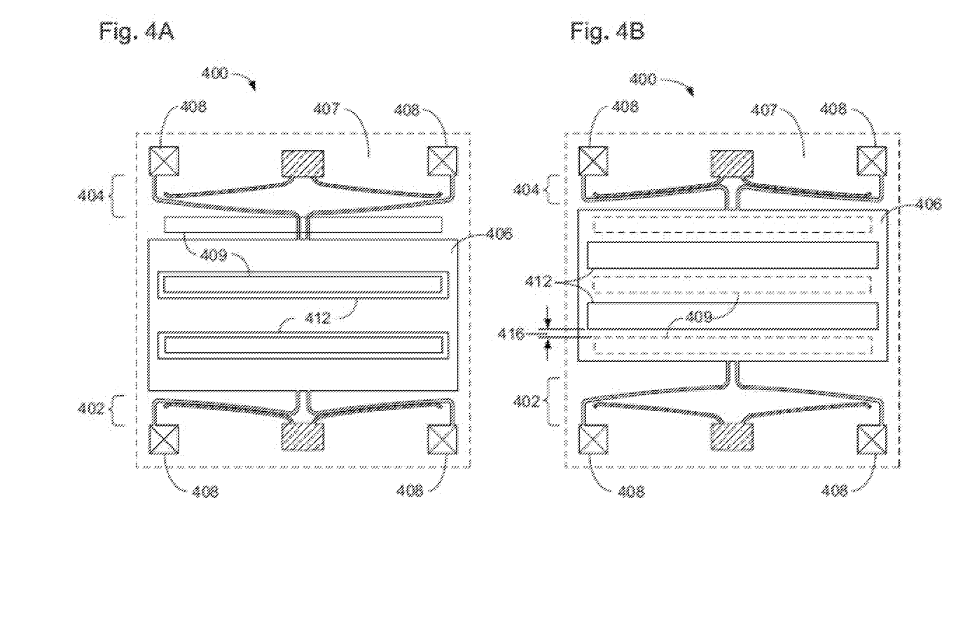

FIGS. 4A and 4B are plan views of a dual-actuated shutter assembly in the open and closed states respectively. In particular, FIGS. 4A and 4B illustrate an alternative shutter-based light modulator (shutter assembly) 400 suitable for inclusion in various implementations. The light modulator 400 is an example of a dual actuator shutter assembly, and is shown in FIG. 4A in an open state. FIG. 4B is a view of the dual actuator shutter assembly 400 in a closed state. In contrast to the shutter assembly 200, shutter assembly 400 includes actuators 402 and 404 on either side of a shutter 406. Each actuator 402 and 404 is independently controlled. A first actuator, a shutter-open actuator 402, serves to open the shutter 406. A second opposing actuator, the shutter-close actuator 404, serves to close the shutter 406. Both actuators 402 and 404 are compliant beam electrode actuators. The actuators 402 and 404 open and close the shutter 406 by driving the shutter 406 substantially in a plane parallel to an aperture layer 407 over which the shutter is suspended. The shutter 406 is suspended a short distance over the aperture layer 407 by anchors 408 attached to the actuators 402 and 404. The inclusion of supports attached to both ends of the shutter 406 along its axis of motion reduces out of plane motion of the shutter 406 and confines the motion substantially to a plane parallel to the substrate. By analogy to the control matrix 300 of FIG. 3A, a control matrix suitable for use with shutter assembly 400 might include one transistor and one capacitor for each of the opposing shutter-open and shutter-close actuators 402 and 404.

The shutter 406 includes two shutter apertures 412 through which light can pass. The aperture layer 407 includes a set of three apertures 409. In FIG. 4A, the shutter assembly 400 is in the open state and, as such, the shutter-open actuator 402 has been actuated, the shutter-close actuator 404 is in its relaxed position, and the centerlines of apertures 412 and 409 coincide. In FIG. 4B the shutter assembly 400 has been moved to the closed state and the shutter-open actuator 402 is in its relaxed position. The shutter-close actuator 404 has been actuated, and the light blocking portions of shutter 406 are in position to block transmission of light through the apertures 409 (shown as dotted lines).

Each aperture has at least one edge around its periphery. For example, the rectangular apertures 409 have four edges. In alternative implementations in which circular, elliptical, oval, or other curved apertures are formed in the aperture layer 407, each aperture may have only a single edge. In other implementations the apertures need not be separated or disjoint in the mathematical sense, but instead can be connected. That is to say, while portions or shaped sections of the aperture may maintain a correspondence to each shutter, several of these sections may be connected such that a single continuous perimeter of the aperture is shared by multiple shutters.

To allow light with a variety of exit angles to pass through apertures 412 and 409 in the open state, it is advantageous to provide a width or size for shutter apertures 412 which is larger than a corresponding width or size of apertures 409 in the aperture layer 407. To effectively block light from escaping in the closed state, the light blocking portions of the shutter 406 may be arranged to overlap the apertures 409. FIG. 4B shows a predefined overlap 416 between the edge of light blocking portions in the shutter 406 and one edge of the aperture 409 formed in aperture layer 407.

The electrostatic actuators 402 and 404 are designed so that their voltage—displacement behavior provides a bi-stable characteristic to the shutter assembly 400. For each of the shutter-open and shutter-close actuators there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vₘ.

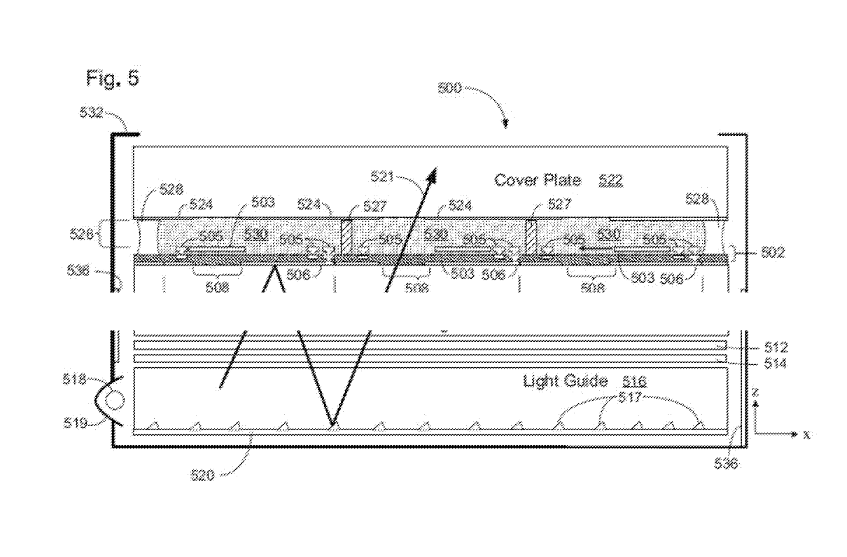

FIG. 5 is a cross sectional view of a shutter-based display apparatus 500 incorporating shutter-based light modulators (shutter assemblies) 502. Each shutter assembly incorporates a shutter 503 and an anchor 505. Not shown are the compliant beam actuators which, when connected between the anchors 505 and the shutters 503, help to suspend the shutters a short distance above the surface. The shutter assemblies 502 are disposed on a transparent substrate 504, that may be made of plastic or glass. A rear-facing reflective layer, reflective film 506, disposed on the substrate 504 defines a plurality of surface apertures 508 located beneath the closed positions of the shutters 503 of the shutter assemblies 502. The reflective film 506 reflects light not passing through the surface apertures 508 back towards the rear of the display apparatus 500. The reflective aperture layer 506 can be a fine-grained metal film without inclusions formed in thin film fashion by a number of vapor deposition techniques including sputtering, evaporation, ion plating, laser ablation, or chemical vapor deposition. In another implementation, the rear-facing reflective layer 506 can be formed from a mirror, such as a dielectric mirror. A dielectric mirror is fabricated as a stack of dielectric thin films which alternate between materials of high and low refractive index. The vertical gap which separates the shutters 503 from the reflective film 506, within which the shutter is free to move, is in the range of 0.5 to 10 microns. The magnitude of the vertical gap may be less than the lateral overlap between the edge of shutters 503 and the edge of apertures 508 in the closed state, such as the overlap 416 shown in FIG. 4B.

The display apparatus 500 includes an optional diffuser 512 and/or an optional brightness enhancing film 514 which separate the substrate 504 from a planar light guide 516. The light guide includes a transparent, i.e., glass or plastic, material. The depicted light guide 516 is illuminated by one or more light sources 518, forming a backlight. The light sources 518 can be, for example, and without limitation, incandescent lamps, fluorescent lamps, lasers, or light emitting diodes (LEDs). A reflector 519 helps direct light from lamp 518 towards the light guide 516. A front-facing reflective film 520 is disposed behind the backlight 516, reflecting light towards the shutter assemblies 502. Light rays such as ray 521 from the backlight that do not pass through one of the shutter assemblies 502 will be returned to the backlight and reflected again from the film 520. In this fashion light that fails to leave the display to form an image on the first pass can be recycled and made available for transmission through other open apertures in the array of shutter assemblies 502. Such light recycling has been shown to increase the illumination efficiency of the display.

The light guide 516 includes a set of geometric light redirectors or prisms 517 which re-direct light from the lamps 518 towards the apertures 508 and hence toward the front of the display. The light re-directors can be molded into the plastic body of light guide 516 with shapes that can be alternately triangular, trapezoidal, or curved in cross section. The density of the prisms 517 generally increases with distance from the lamp 518.

In alternate implementations, the aperture layer 506 can be made of a light absorbing material, and in alternate implementations the surfaces of shutter 503 can be coated with either a light absorbing or a light reflecting material. In alternate implementations the aperture layer 506 can be deposited directly on the surface of the light guide 516. In alternate implementations the aperture layer 506 need not be disposed on the same substrate as the shutters 503 and anchors 505 (see the MEMS-down configuration described below).

A cover plate 522 forms the front of the display apparatus 500. The rear side of the cover plate 522 can be covered with a black matrix 524 to increase contrast. In alternate implementations the cover plate 522 includes color filters, for instance distinct red, green, and blue filters corresponding to different ones of the shutter assemblies 502. The cover plate 522 is supported a predetermined distance away from the shutter assemblies 502 forming the depicted gap 526. The gap 526 is maintained by mechanical supports or spacers 527 and/or by an adhesive seal 528 attaching the cover plate 522 to the substrate 504.

The adhesive seal 528 seals in a working fluid 530. The working fluid 530 is engineered with viscosities that may be below about 10 centipoise and with relative dielectric constant that may be above about 2.0, and dielectric breakdown strengths above about 10⁴ V/cm. The working fluid 530 can also serve as a lubricant. In one implementation, the working fluid 530 is a hydrophobic liquid with a high surface wetting capability. In alternate implementations the working fluid 530 has a refractive index that is either greater than or less than that of the substrate 504.

When the MEMS-based display assembly includes a liquid for the working fluid 530, the liquid at least partially surrounds the moving parts of the MEMS-based light modulator. To reduce the actuation voltages, the liquid has a viscosity that may be below 70 centipoise, or even below 10 centipoise. Liquids with viscosities below 70 centipoise can include materials with low molecular weights: below 4000 grams/mole, or in some cases below 400 grams/mole. Suitable working fluids 530 include, without limitation, de-ionized water, methanol, ethanol and other alcohols, paraffins, olefins, ethers, silicone oils, fluorinated silicone oils, or other natural or synthetic solvents or lubricants. Useful working fluids can be polydimethylsiloxanes, such as hexamethyldisiloxane and octamethyltrisiloxane, or alkyl methyl siloxanes such as hexylpentamethyldisiloxane. Useful working fluids can be alkanes, such as octane or decane. Useful fluids can be nitroalkanes, such as nitromethane. Useful fluids can be aromatic compounds, such as toluene or diethylbenzene. Useful fluids can be ketones, such as butanone or methyl isobutyl ketone. Useful fluids can be chlorocarbons, such as chlorobenzene. Useful fluids can be chlorofluorocarbons, such as dichlorofluoroethane or chlorotrifluoroethylene. And other fluids considered for these display assemblies include butyl acetate, dimethylformamide.

For many implementations, it is advantageous to incorporate a mixture of the above fluids. For instance mixtures of alkanes or mixtures of polydimethylsiloxanes can be useful where the mixture includes molecules with a range of molecular weights. It is also possible to optimize properties by mixing fluids from different families or fluids with different properties. For instance, the surface wetting properties of a hexamethyldisiloxane and be combined with the low viscosity of butanone to create an improved fluid.

A sheet metal or molded plastic assembly bracket 532 holds the cover plate 522, the substrate 504, the backlight 516 and the other component parts together around the edges. The assembly bracket 532 is fastened with screws or indent tabs to add rigidity to the combined display apparatus 500. In some implementations, the light source 518 is molded in place by an epoxy potting compound. Reflectors 536 help return light escaping from the edges of light guide 516 back into the light guide. Not shown in FIG. 5 are electrical interconnects which provide control signals as well as power to the shutter assemblies 502 and the lamps 518.

Display apparatus 500 is referred to as the MEMS-up configuration, where the MEMS based light modulators are formed on a front surface of substrate 504, i.e. the surface that faces toward the viewer. The shutter assemblies 502 are built directly on top of the reflective aperture layer 506. In an alternate implementation, referred to as the MEMS-down configuration, the shutter assemblies are disposed on a substrate separate from the substrate on which the reflective aperture layer is formed. The substrate on which the reflective aperture layer is formed, defining a plurality of apertures, is referred to herein as the aperture plate. In the MEMS-down configuration, the substrate that carries the MEMS-based light modulators takes the place of the cover plate 522 in display apparatus 500 and is oriented such that the MEMS-based light modulators are positioned on the rear surface of the top substrate, i.e. the surface that faces away from the viewer and toward the back light 516. The MEMS-based light modulators are thereby positioned directly opposite to and across a gap from the reflective aperture layer. The gap can be maintained by a series of spacer posts connecting the aperture plate and the substrate on which the MEMS modulators are formed. In some implementations, the spacers are disposed within or between each pixel in the array. The gap or distance that separates the MEMS light modulators from their corresponding apertures may be less than 10 microns, or a distance that is less than the overlap between shutters and apertures, such as overlap 416.

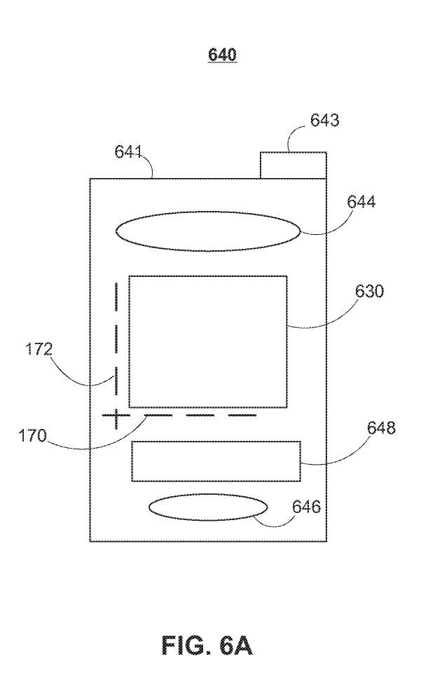

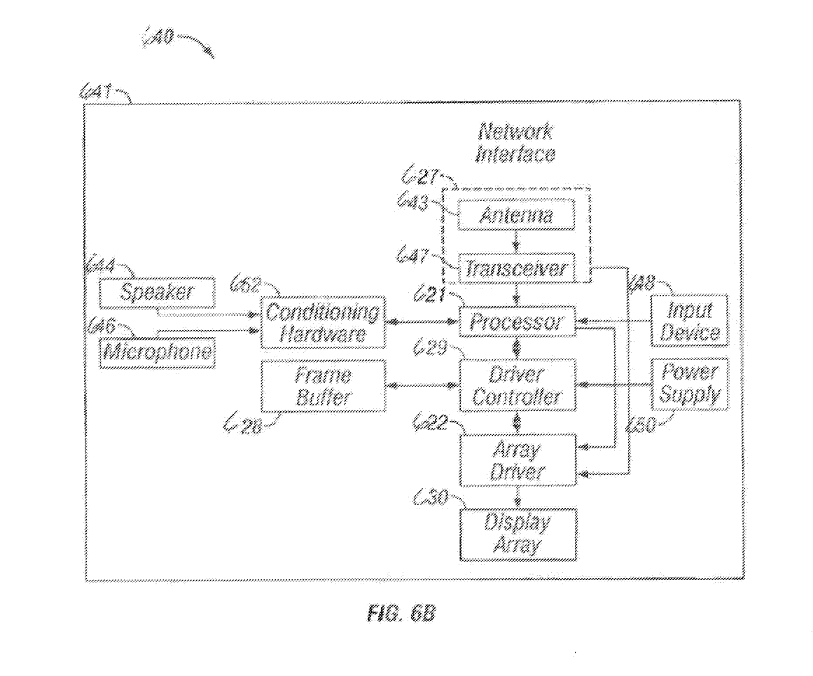

FIGS. 6A and 6B are system block diagrams illustrating a display device 640 that includes a plurality of light modulator display elements. The display device 640 can be, for example, a smart phone, a cellular or mobile telephone. However, the same components of the display device 640 or slight variations thereof are also illustrative of various types of display devices such as televisions, computers, tablets, e-readers, hand-held devices and portable media devices.

The display device 640 includes a housing 641, a display 630, an antenna 643, a speaker 645, an input device 648 and a microphone 646. The housing 641 can be formed from any of a variety of manufacturing processes, including injection molding, and vacuum forming. In addition, the housing 641 may be made from any of a variety of materials, including, but not limited to: plastic, metal, glass, rubber and ceramic, or a combination thereof. The housing 641 can include removable portions (not shown) that may be interchanged with other removable portions of different color, or containing different logos, pictures, or symbols.

The display 630 may be any of a variety of displays, including a bi-stable or analog display, as described herein. The display 630 also can be configured to include a flat-panel display, such as plasma, EL, OLED, STN LCD, or TFT LCD, or a non-flat-panel display, such as a CRT or other tube device. In addition, the display 630 can include an light modulator-based display, as described herein.

The components of the display device 640 are schematically illustrated in FIG. 6A. The display device 640 includes a housing 641 and can include additional components at least partially enclosed therein. For example, the display device 640 includes a network interface 627 that includes an antenna 643 which can be coupled to a transceiver 647. The network interface 627 may be a source for image data that could be displayed on the display device 640. Accordingly, the network interface 627 is one example of an image source module, but the processor 621 and the input device 648 also may serve as an image source module. The transceiver 647 is connected to a processor 621, which is connected to conditioning hardware 652. The conditioning hardware 652 may be configured to condition a signal (such as filter or otherwise manipulate a signal). The conditioning hardware 652 can be connected to a speaker 645 and a microphone 646. The processor 621 also can be connected to an input device 648 and a driver controller 629. The driver controller 629 can be coupled to a frame buffer 628, and to an array driver 622, which in turn can be coupled to a display array 630. One or more elements in the display device 640, including elements not specifically depicted in FIG. 6A, can be configured to function as a memory device and be configured to communicate with the processor 621. In some implementations, a power supply 650 can provide power to substantially all components in the particular display device 640 design.

The network interface 627 includes the antenna 643 and the transceiver 647 so that the display device 640 can communicate with one or more devices over a network. The network interface 627 also may have some processing capabilities to relieve, for example, data processing requirements of the processor 621. The antenna 643 can transmit and receive signals. In some implementations, the antenna 643 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 643 transmits and receives RF signals according to the Bluetooth® standard. In the case of a cellular telephone, the antenna 643 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 647 can pre-process the signals received from the antenna 643 so that they may be received by and further manipulated by the processor 621. The transceiver 647 also can process signals received from the processor 621 so that they may be transmitted from the display device 40 via the antenna 643.

In some implementations, the transceiver 647 can be replaced by a receiver. In addition, in some implementations, the network interface 627 can be replaced by an image source, which can store or generate image data to be sent to the processor 621. The processor 621 can control the overall operation of the display device 640. The processor 621 receives data, such as compressed image data from the network interface 627 or an image source, and processes the data into raw image data or into a format that can be readily processed into raw image data. The processor 621 can send the processed data to the driver controller 629 or to the frame buffer 628 for storage. Raw data typically refers to information that identifies the image characteristics at each location within an image. For example, such image characteristics can include color, saturation and grayscale level.

The processor 621 can include a microcontroller, CPU, or logic unit to control operation of the display device 640. The conditioning hardware 652 may include amplifiers and filters for transmitting signals to the speaker 645, and for receiving signals from the microphone 646. The conditioning hardware 652 may be discrete components within the display device 640, or may be incorporated within the processor 621 or other components.

The driver controller 629 can take the raw image data generated by the processor 621 either directly from the processor 621 or from the frame buffer 628 and can re-format the raw image data appropriately for high speed transmission to the array driver 622. In some implementations, the driver controller 629 can re-format the raw image data into a data flow having a raster-like format, such that it has a time order suitable for scanning across the display 630. Then the driver controller 629 sends the formatted information to the array driver 622. Although a driver controller 629, such as an LCD controller, is often associated with the system processor 621 as a stand-alone Integrated Circuit (IC), such controllers may be implemented in many ways. For example, controllers may be embedded in the processor 621 as hardware, embedded in the processor 621 as software, or fully integrated in hardware with the array driver 622.

The array driver 622 can receive the formatted information from the driver controller 629 and can re-format the video data into a parallel set of waveforms that are applied many times per second to the hundreds, and sometimes thousands (or more), of leads coming from the display's x-y matrix of display elements.

In some implementations, the driver controller 629, the array driver 622, and the display 630 are appropriate for any of the types of displays described herein. For example, the driver controller 629 can be a conventional display controller or a bi-stable display controller (such as a light modulator display element controller). Additionally, the array driver 622 can be a conventional driver or a bi-stable display driver (such as a light modulator display element driver). Moreover, the display array 630 can be a conventional display array or a bi-stable display array (such as a display including an array of light modulator display elements). In some implementations, the driver controller 629 can be integrated with the array driver 622. Such an implementation can be useful in highly integrated systems, for example, mobile phones, portable-electronic devices, watches or small-area displays.

In some implementations, the input device 648 can be configured to allow, for example, a user to control the operation of the display device 640. The input device 648 can include a keypad, such as a QWERTY keyboard or a telephone keypad, a button, a switch, a rocker, a touch-sensitive screen, a touch-sensitive screen integrated with the display array 630, or a pressure- or heat-sensitive membrane. The microphone 646 can be configured as an input device for the display device 640. In some implementations, voice commands through the microphone 46 can be used for controlling operations of the display device 640.

The power supply 650 can include a variety of energy storage devices. For example, the power supply 650 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 650 also can be a renewable energy source, a capacitor, or a solar cell, including a plastic solar cell or solar-cell paint. The power supply 650 also can be configured to receive power from a wall outlet.

In some implementations, control programmability resides in the driver controller 629 which can be located in several places in the electronic display system. In some other implementations, control programmability resides in the array driver 622. The above-described optimization may be implemented in any number of hardware and/or software components and in various configurations.

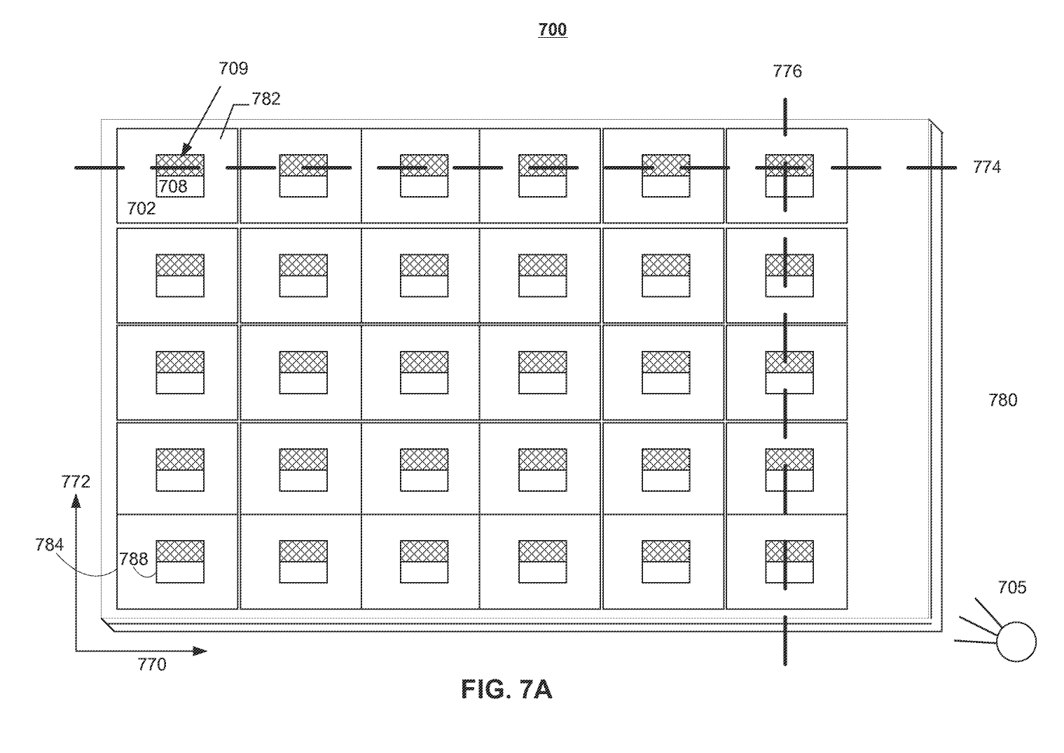

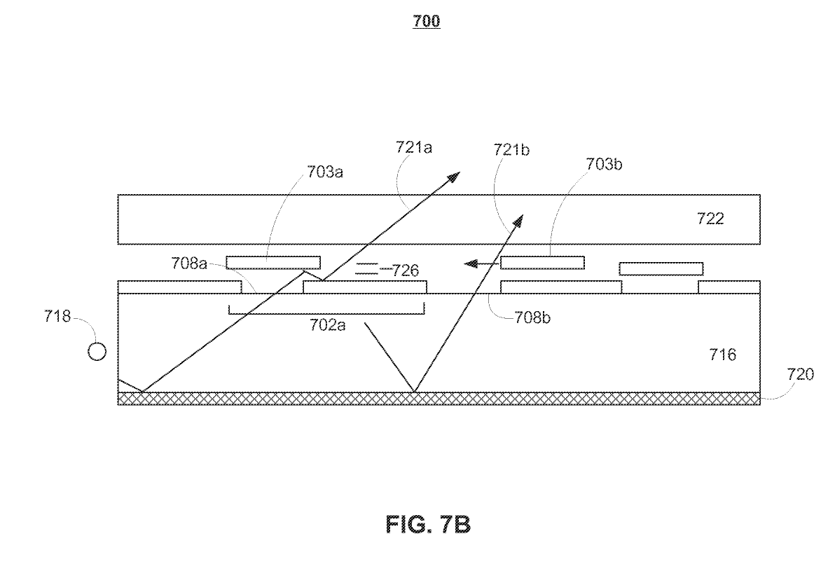

The display 630 depicted in FIG. 6A may have a light modulating array that has a plurality of light modulators laid out in an array having the axes 170 and 172. FIGS. 7A and 7B are a plan and a cross-sectional view of a shutter-based display, respectively. FIG. 7A is a block diagram of a display having an array of shutter assemblies. FIG. 7A illustrates pictorially a display 700 similar to the display 100 shown in FIG. 1A and of the type that can be used as a display 630 for display device 640. In particular FIG. 7A depicts a display 700 that is formed from a plurality of light modulators 702 that are arranged in a two dimensional array 780 of rows 774 and columns 776. As depicted in FIG. 7A each of the light modulators 702 includes a shutter assembly that has a shutter 708 that moves back and forth over an aperture 709. The shutter 708 moves across the aperture 709 to modulate light from the light source 705 which is disposed on one side of the array 780 of light modulators 702. In the depicted implementation, the display 700 is a back lit display and the shutters 708 move back and forth across the aperture 709 to modulate the light from light source 705 as that light passes through the different apertures 709 of the array 780. FIG. 7A depicts five rows and seven columns of shutter assemblies 702. Thus, FIG. 7A only depicts a portion of an array 780 that would provide pixels for a display. Typically, a display would employ an array 780 to have several hundred rows and several hundred columns. For example, the display 700 may conform to the WVGA standard and have 848 columns and 480 rows, or the WXGA standard and have 1,280 columns and 800 rows. In either case, the array 780 would include thousands of shutter assemblies arranged into an array, as depicted by the array 780 shown in FIG. 7A.

FIG. 7A further depicts that each light modulator 702 has a square peripheral edge 782 that defines the perimeter of the light modulator 702. Typically, the peripheral edge 782 of the light modulator 702 is defined by the data and scan line interconnects, such as the data interconnects 708 and scan line interconnects 306 depicted in FIG. 3B. The peripheral edge 782 has a horizontal and vertical axis that are aligned with the horizontal and vertical 770 and 772 of the array 780. Similarly, each shutter 708 has a peripheral edge 788, that is also rectangular and is also aligned with the axes 770 and 772 of the array 780. In operation, each shutter 708 moves back and forth over its respective aperture 709, moving along an axis of motion that is parallel to the axis 772 of display array 780. The array 780 forms part of a display that typically has a rectangular perimeter, such as the display 630 depicted in FIG. 6A. Images are presented on the display 700 as being aligned with axes 770 and 772 of the rectangular display 700. The quality of an image presented on the display 700 may vary depending upon the angle at which the image is viewed. For example, an image viewed from directly overhead and looking down onto the display 700 may have high clarity and high resolution. Such a viewing angle is essentially perpendicular to the surface of the array 780 of display 700. As the viewing angle changes from being perpendicular to an acute angle, the quality of the image clarity may reduce.

FIG. 7B is a cross-sectional view of a shutter-based display having a shutter positioned to block light. FIG. 7B depicts in more detail how a shutter moves across an aperture to modulate light passing through the aperture and how light passing under a closed shutter may reduce image clarity at certain viewing angles. In particular, FIG. 7B presents a simplified cross sectional view of the display depicted in FIG. 5. In particular FIG. 7B depicts display 700 that includes shutters 703 that move over apertures 708 to block light such as the light rays 721 A and 721 B generated from the light source 718. Light source 718 directs light into the light guide 716 which guides light underneath the surface of the shutter assemblies 702. A reflective surface 720 reflects light upward towards the apertures 708 for modulation by the shutters 703. Cover plate 722 is arranged against one side of the shutter assemblies 702.

FIG. 7B depicts shutter 703A as being disposed over an aperture 708A. FIG. 7B also depicts shutter 703B as being spaced away from aperture 708B so that light from the light source 718 can pass from the light guide 716 through the aperture 708B and through the cover plate 722. FIG. 7B depicts the shutter 703B in an open position and the shutter 703A in a closed position. The shutter 703A in the closed position should block light from light source 718 from passing through the aperture 708A and onward through the cover plate 722. However, FIG. 7B depicts that even in a closed position, light at a certain angle may pass through the aperture 708A and through the gap 726 that exists between the closed shutter 703A and the lower surface of the shutter assembly 702A. Light passing through an aperture, such as aperture 708A, that has been closed by a shutter 703A reduces the effectiveness of that respective shutter 703A for modulating the amount of light that will pass through the aperture 708A when the shutter is in the open position and the closed position. The gap 726 depicted in FIG. 7B allows light that is at a sufficiently high angle to reflect off the surface of the shutter 703A facing the light source and reflect again off the opposite surface of the shutter 702A, reflecting off the shutter assembly 702A at an angle that is sufficiently high to avoid being blocked by the portion of the shutter 703A that extends over the shutter assembly 702A. Light 721A that travels through gap 726 travels along an angle that is acute to the surface of coverplate 722. This light 721A passing through gap 726 will affect most strongly a user viewing the display 700 at an angle substantially similar to the angle of the light ray 721A. The amount of light passing through a gap, such as gap 726 will depend, in part, on the overlap between the shutter 703 and the aperture 708. The overlap between the shutter 703 and the aperture 708 may be different for the overlap along the width of the shutter and the overlap along the length of the shutter.

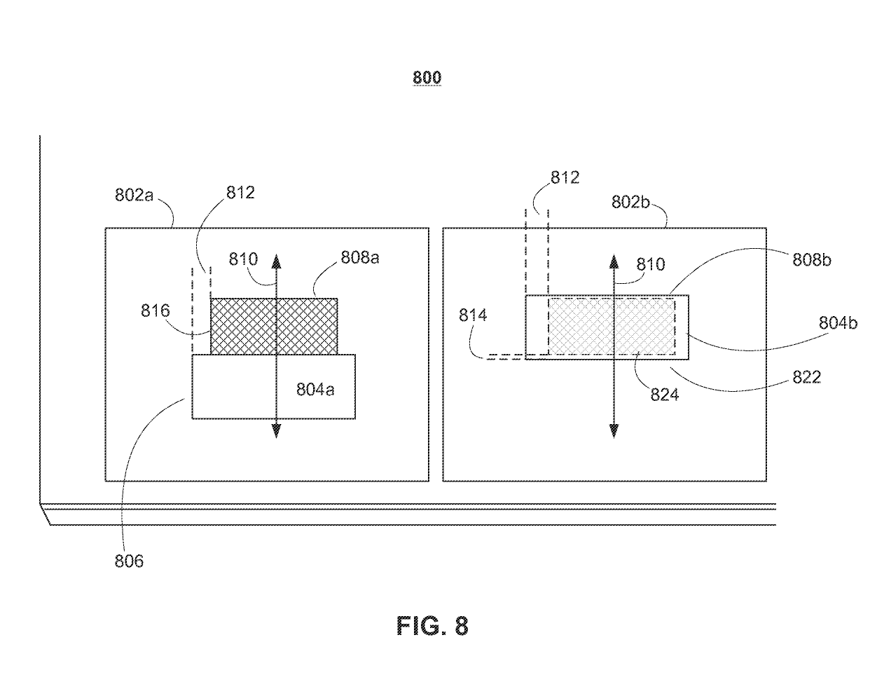

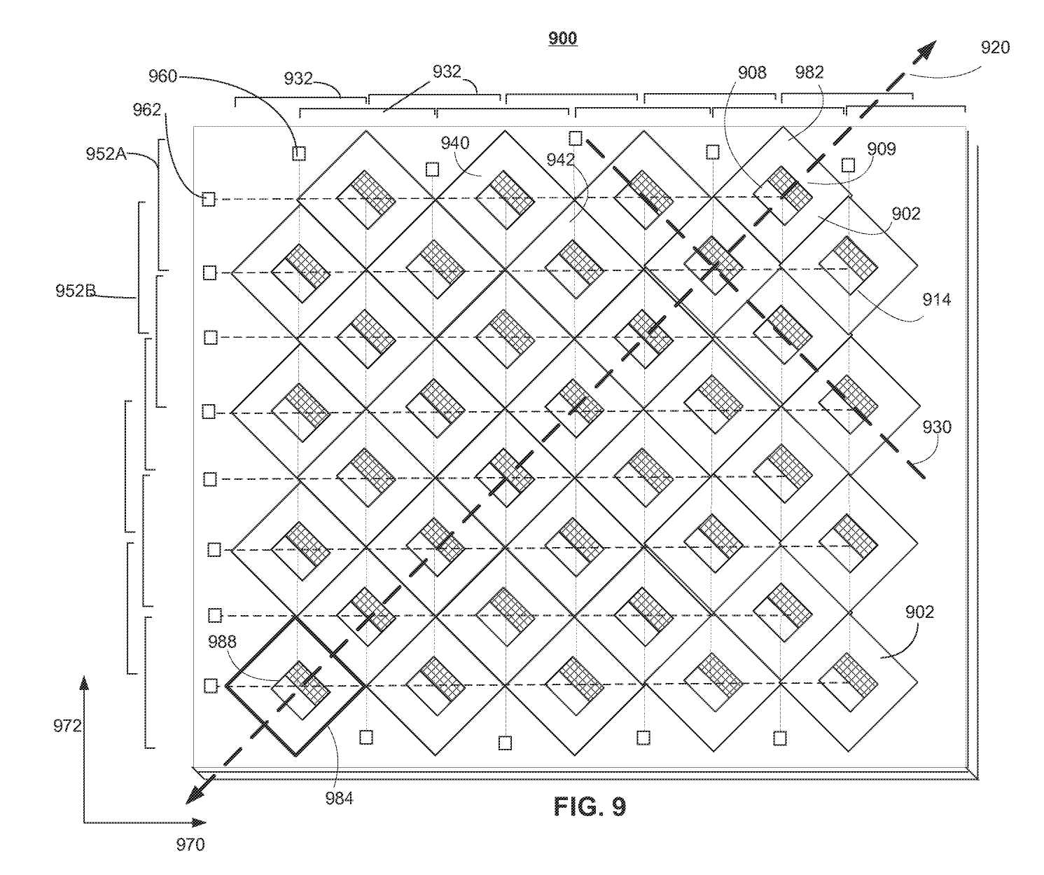

FIG. 8 depicts a plan view of a shutter moved away from an aperture and a shutter moved over an aperture. In particular, FIG. 8 illustrates that the overlap between a shutter and an aperture may be larger along the axis of motion of the shutter than the overlap along an axis that is perpendicular to the axis of motion. In particular, FIG. 8 depicts a pair of shutters 800, similar to the shutters 703A and 703B of FIG. 7. The depicted shutter assembly 802A is shown in the open position such that the shutter 804A is spaced away from the aperture 808A to allow light to pass through the aperture 808A. In contrast, the shutter 804B is shown as positioned over the aperture 808B which is presented in a ghosted outline to depict the aperture 808B as being covered by the shutter 804B. The shutter assembly 802A depicts that the overlap between the peripheral edge of the shutter 804A that is parallel to an axis of motion 810, overlaps and extends past the aperture 808A a distance 812. Specifically, FIG. 8 depicts that the shutter 804A has a side edge 806 that is parallel to the axis of motion 810. Similarly, the aperture 808A has a side edge 816 that is also parallel to the axis of motion 810. The side edge 806 is spaced from the side edge 816 by a distance 812. This distance 812 represents the overlap that the shutter 804A extends over the peripheral edge 816 of the aperture 808A. The overlap 812 is typically sufficiently large to block light that is passing between the shutter 804A and the aperture 808A. In contrast, shutter 804B is depicted as positioned over the aperture 808B. The shutter 804B has a side edge 822 that is perpendicular to the axis of motion 810. Similarly, the aperture 808B has a side edge 824 that is also perpendicular to the axis of motion 810. FIG. 8 illustrates that the side edge 822 of the shutter 804B is spaced a distance 814 away from the side edge 824 of the aperture 804B. The overlap 814 depicted in FIG. 8 is illustrated as smaller than the overlap 812, thus providing a smaller amount of overlap between the side edge 824 of the aperture 808B and the side edge 822 of the shutter 804B. The smaller overlap 814 between these two edges allows more light to pass between the aperture 808B and the shutter 804B along the edge of the shutter that is perpendicular to the axis of motion 810. Thus, light passing through the aperture 808B and traveling towards the side edge 822 of the shutter 804B and along a high angle, such as ray 721A illustrated in FIG. 7B, may pass under the overlap 812 and be made part of an image that is viewed along a viewing angle that is aligned with the path of light escaping from under the edge 822 of shutter 804B. As a display will commonly present images with an orientation that aligns the image with the horizontal axis of the display, such as axis 170 of display 30 in FIG. 6A, and a user will commonly view the image looking towards the horizontal axis, the alignment of the peripheral edge 822 and the horizontal axis of the display can cause the light escaping under edge 822 to interfere with image quality.

FIG. 9 depicts a plan view of a display having rotated shutter assemblies. More particularly, FIG. 9 depicts one implementation of the systems and methods described herein wherein a display 900 includes a plurality of shutter assemblies 902 that are arranged in an array having the axis of motion 920 of the shutters 908 disposed at an angle relative to the axis 970 and 972 of the peripheral edge of the display 900.

In particular FIG. 9 depicts a display 900 that includes a plurality of shutter assemblies 902. The shutter assemblies include shutters 908 that move over and away from an aperture 909. The shutters 908 are formed on a base 982 that has a peripheral edge 984, depicted as square in FIG. 9. Similarly, each shutter 908 depicted in FIG. 9 is a rectangular element that has a peripheral edge 988. FIG. 9 depicts an axis 920 extending along the axis of motion of the shutters 908 in display 900. That is, the shutters 908 move in a direction substantially parallel to the axis 920.

The shutter assemblies 902 may be pixels or subpixels in the display 900. The shutter assemblies 902 can be arranged into rows and columns. The shutters 908 move along a path parallel to the axis 920, and therefore the shutter motion is along an axis that is at an angle relative to the axes 970 and 972 of the display 900. This orients the side edge 914 of the shutter 908 along the axis 920.

In the implementation depicted in FIG. 9, the shutter assemblies 902 are turned to align their peripheral edges 984 at about a 45° angle to the axes 970 and 972 of the display 900. This arranges the shutter assemblies 902 in a diamond pattern of columns 932 and rows 952. The shutter assemblies 902 of the diamond pattern have shutter assemblies of adjacent columns, such as shutter assembly 940 and shutter assembly 942, in different and spatially offset rows. Specifically, shutter assembly 940 is adjacent to shutter assembly 942, and in the depicted example shutter assembly 940 abuts shutter assembly 942 along on side. Shutter assembly 940 is in row 952A and shutter assembly 942 is in row 952B, which is spatially offset, depicted as lower in FIG. 9, from shutter assembly 940.

FIG. 9 further depicts that the centers of the shutter assemblies 902, which are in adjacent columns, are aligned along an axis, such as the motion of axis 920, that extends at angle of substantially 45° relative to either axes 970 and 972. Moreover, FIG. 9 depicts that the shutters 908 are rectangular, and that the rectangular side edges of the shutter 908 are arranged at an angle, in the depicted example a 45° angle, relative to the axes 970 and 972. This arranges the side edge of the shutter 902 with the smaller overlap over aperture 909, such as the depicted overlap 814 shown in FIG. 8, to traverse the axis of motion 920, and at an angle, in this case about 45°, relative to the axes 970 and 972. Although FIG. 9 depicts the shutter assemblies 902 as aligned at an angle 45° relative to the axes of 970 and 972 of the display 900, it will be apparent to those of skill in the art that other angles of orientation may be used, including any angle that aligns a side of the shutter 908 to be angled away from both axes 970 and 972. Moreover, the angle selected will depend in part on the peripheral shape of a shutter assembly, which in FIG. 9 are shown as squares, but may be other rectangles, circles, hexagons, a non-linear shape, or any other shape.

FIG. 9 further depicts control lines 960 and 962. The control lines 960 extend through columns of shutter assemblies 902 in the display 900 and the control lines 962 extend through the rows of shutter assemblies 902 in the display 900. In this depicted implementation, the control lines 960 and 962 provide for addressing the shutter assemblies 902 within the diamond layout display 900 in a manner that is similar to that of a conventional square layout display. The display 900 has row and column control lines 960 and 962 that extend in roughly substantially straight line shapes through the array of shutter assemblies 902. In some implementations, the straight control lines 960 and 962 match the control line structure of the conventional square layout and the display signal generated for square layout can be directly displayed on the diamond layout, and thus, no re-mapping is necessary.

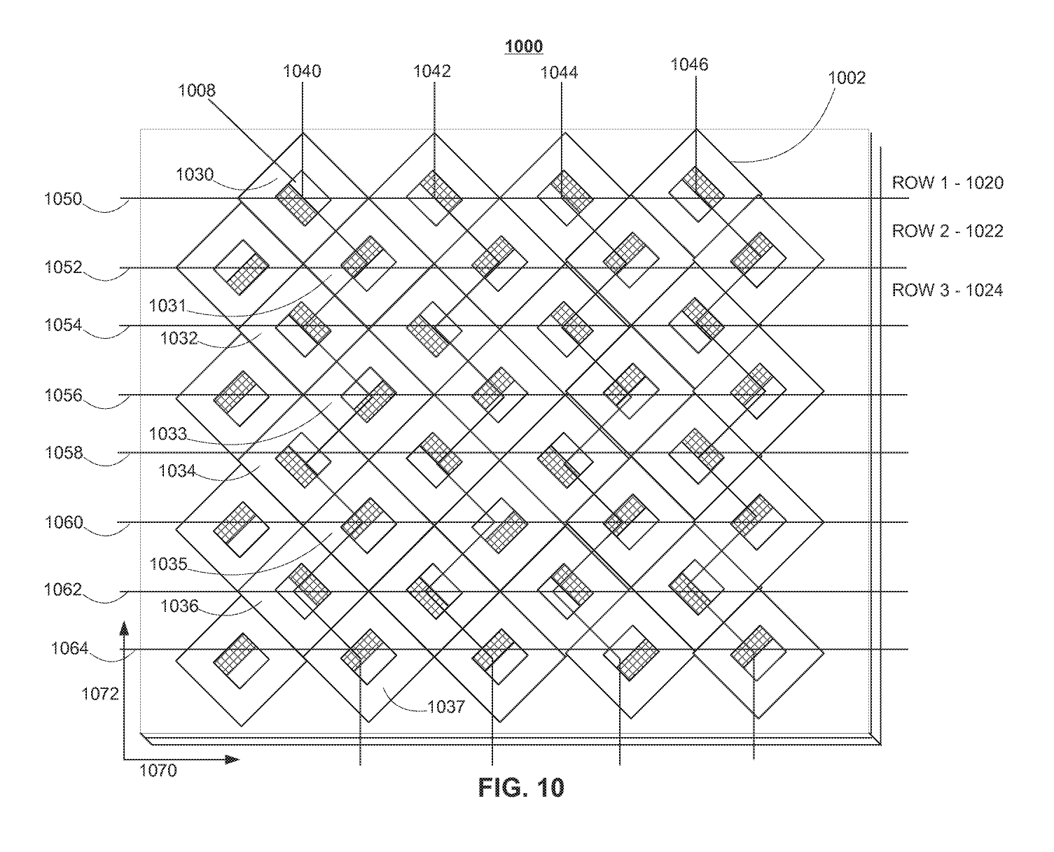

Turning to FIG. 10, FIG. 10 depicts an alternate implementation of a display having rotated shutter assemblies. In particular, FIG. 10 depicts a display 1000 having a plurality of shutter assemblies 1002 organized in a diamond layout that aligns the axes of motion of the respective shutters 1002 at an angle traverse to the axes of the display 1070 and 1072. In the depicted implementation the axes of motion of the respective shutters 1002 are angled at approximately 45° to both axes 1070 and 1072 of the display 1000. In this way the shutter assembly 1002 orients its short edge axis of the shutter 1008 at 45° to the axes of display. As such, light emitted from a gap existing at the peripheral edge of the shutter assembly that is perpendicular to the axis of motion of the shutter assembly, is directed off-axis to the major viewing axes of images presented on the display.

As FIG. 10 further depicts, shutter assemblies 1002 in adjacent rows are rotated 90° relative to their axes of motion. For example, the axes of motion of the shutter assemblies 1002 in row 1020 are orthogonal to the axes of motion of the shutter assemblies 1002 in row 1022. In the depicted implementation successive rows alternate the orientation of the shutter assemblies 1002, thereby having shutter assemblies 1002 in adjacent rows to be rotated 90° relative to each other. This can improve off-axis contrast ratio and therefore improve the quality of the displayed image when that image is viewed at an angle that is transverse to the peripheral edge of the display 1000.

Additionally, FIG. 10 depicts control lines for controlling operation of the shutter assemblies 1002. In particular, FIG. 10 depicts column control lines 1040, 1042, 1044 and 1046. FIG. 10 depicts row control lines 1050 through 1064. The column control lines 1040 through 1046 connect to shutter assemblies 1002 that are in immediately adjacent rows. For example, FIG. 10 shows column control line 1040 connecting to shutter assemblies 1030-1037. Thus, control line 1040 connects to shutter assembly 1030, which is in row 1020 and connects to shuttle assembly 1031, which is row 1022, and so forth. As depicted in FIG. 10 the control lines 1040 through 1046 have a zigzag pattern as they connect shutter assemblies 1002 in adjacent rows. The row control lines 1050 through 1064 connect, in this implementation, to each shutter assembly 1002 in a respective row of the display 1000.

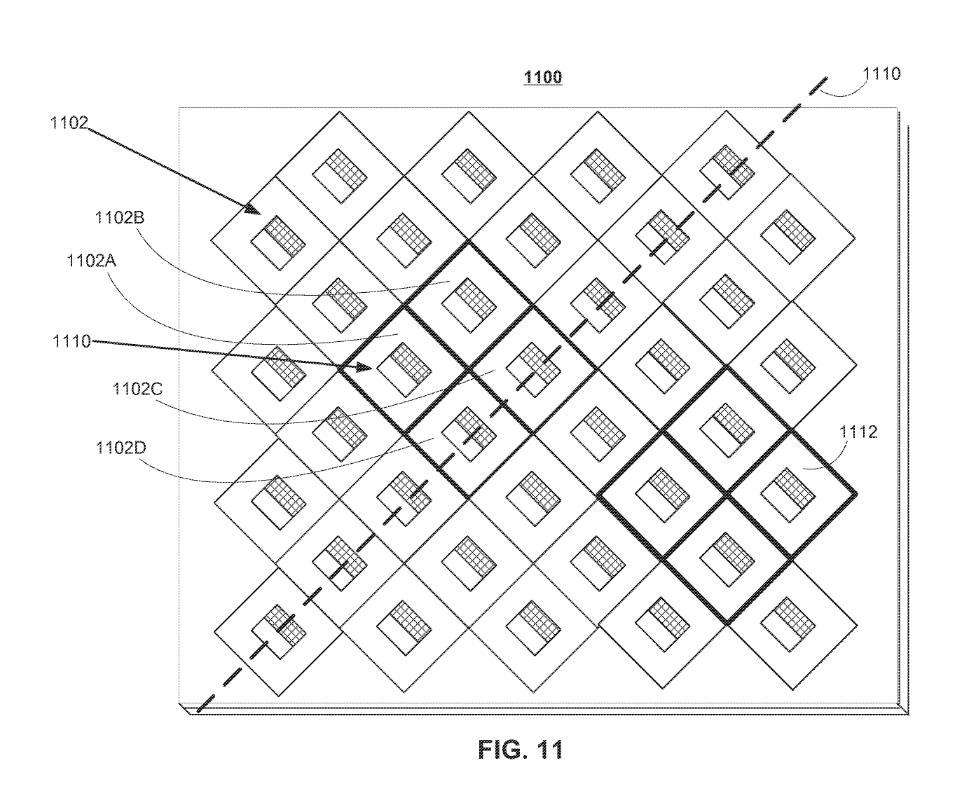

FIG. 11 depicts a plurality of shutter assemblies grouped as a logical pixel. In particular, FIG. 11 depicts a further alternative implementation of the systems and methods described herein. Specifically, FIG. 11 depicts a display 1100 having a plurality of shutter assemblies 1102 oriented in a diamond pixel layout such as the diamond pixel layout presented in FIG. 10. The display 1100 depicted in FIG. 11 further includes a logical pixel 1110 that, in the depicted implementation, includes four shutter assemblies 1102A, 1102B, 1102C and 1102D. A second logical pixel 1112 is also shown in FIG. 11 and also includes four shutter assemblies. The depicted logical pixels 1110 and 1112 may be treated by the controller, such as the controller 156 depicted in FIG. 1B as a single pixel element within the display 1100. To this end the controller 150 may drive the four shutter assemblies of the logical pixel, such as the shutter assemblies 1102A through 1102D of logical pixel 1110, together. Driving the shutter assemblies 1102A through 1102D together has certain benefits including reducing the bandwidth needed to control the pixels of the display, which may be an important benefit for large displays having thousands or millions of shutter assemblies acting as pixels within the display. Additionally, it is understood that the logical pixel may also provide the benefit of mitigating image quality artifacts by providing grayscaling, including dithered grayscaling, to improve image quality.

In one implementation, the display controller 156 selects certain shutter assemblies 1102 to group together into the logical pixel 1110 or 1112. In one practice, the logical controller 156 includes a sub-pixel lookup table that stores data, typically row and column information, representative of the shutter assemblies 1102 being grouped into the logical pixels 1110 and 1112. The sequencer timing control 160 can access the sub-pixel lookup table when controlling the scan drivers 152 and data drivers 154 to actuate the shutters of the shutter assemblies 1102 within the display 1100. Optionally, the controller 156 can alter the shutter assemblies 1102 that are grouped together into a logical pixel 1110. Further optionally, the grouping may change during the production of an image. Thus, the controller 156 may effectively move the location of the logical pixel 1110 or 1112 to a different location within the overall array of the display 1100. This allows the controller 156 to spatially average groups of pixels being presented as part of an image. Additionally, the controller 156 can coordinate the lamp drivers 168 to spatially average different colors, such as the color blue driven by lamp 166, across an image being presented on the display 1100. In this way, the logical pixels 1110 and 1112 reduce bandwidth for producing images and provide for reduction in artifacts by allowing spatial grayscaling including grayscaling for selected colors, during image production.

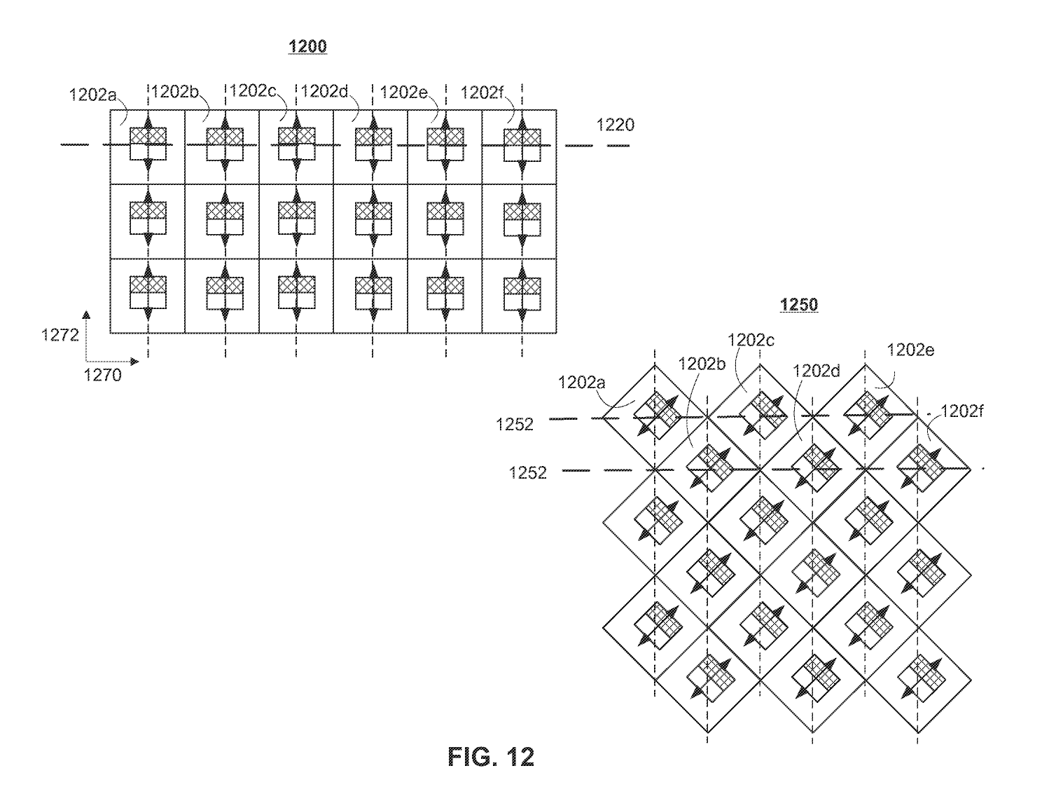

FIG. 12 depicts relative pixel pitch between a display with shutter assemblies aligned to a display and a display with shutter assemblies rotated relative to the display. FIG. 12 depicts one benefit of the diamond pixel layout described above. In particular, FIG. 12 depicts an array 1200 of shutter assemblies 1202 aligned in a grid 1204 that has axes 1270 and 1272. As depicted in FIG. 12, the shutter assemblies 1202 in the display 1200 move along an axis of motion 1210. The axis of motion 1210 is traverse to the axes 1270 and 1272 of the display 1200. The pixel-per-inch metric of the display 1200 may be measured by counting the number of shutter assemblies 1202 that are placed within a nominal row of the display 1200 over a defined length, such as an inch. In the implementation depicted in FIG. 12 the display 1200 aligns six shutter assemblies 1202A through 1202F along row 1220.

By comparison, the diamond pixel layout 1250 depicted in FIG. 12 illustrates that the shutter assemblies 1202 placed within the diamond pixel layout of display 1250 are aligned to place six shutter assemblies 1202A-1202F along two rows 1252 over a shorter length than the six shutter assemblies 1202A-1202F placed in the display 1200. As such, the diamond pixel layout of display 1250 provides a greater pixel per inch metric and improved resolution, assuming the pixel size keeps the same.

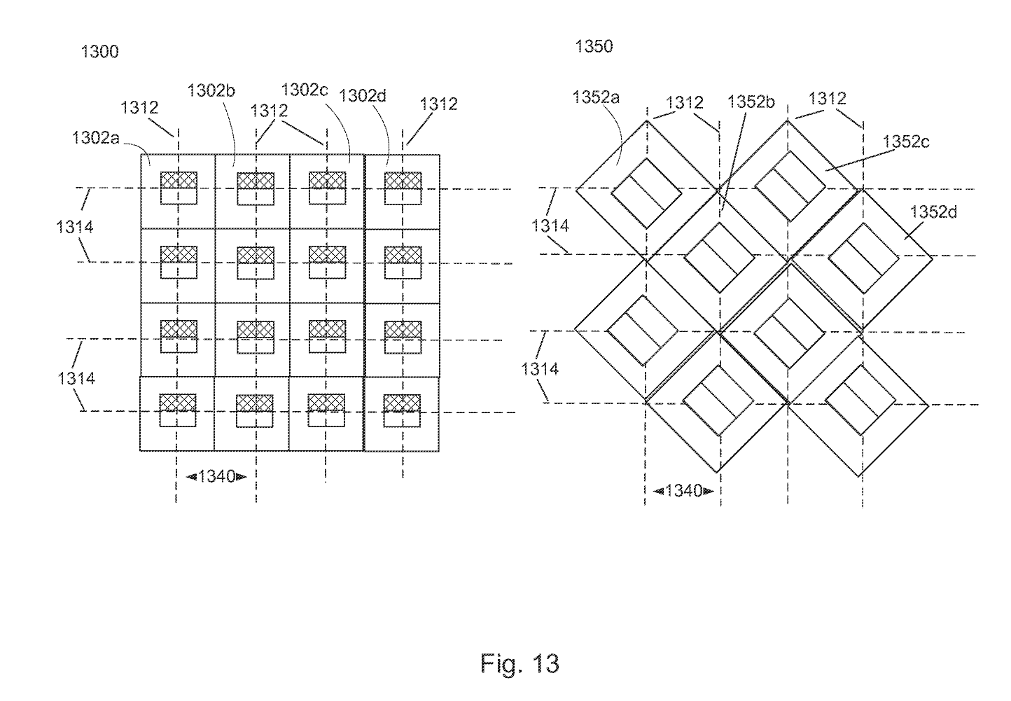

FIG. 13 depicts two arrays 1300 and 1350 having similar control line densities and pixels with different sized apertures and different aperture ratios. In particular, FIG. 13 depicts a first array 1300 that includes a 4×4 array of shutter assemblies 1302. The 4×4 array is controlled by four control lines 1312 extending along each column of the array 1300 and four control lines 1314 extending along each row of the array 1300. The pitch between each pair of adjacent control lines 1312 is depicted as 1340 and that pitch defines the control line density representing the density of control lines 1312 across array 1300. Array 1300 has a density of four control lines over the width of four shutter assemblies 1302, where the width of the four shutter assemblies may be some known length typically measured in microns, but any unit of length may be employed.

Array 1350 also has four control lines 1312 extending along each column of the array 1350 and four control lines 1314 extending along each row of the array 1350. The pitch between adjacent control lines 1312 is also depicted as 1340 and it will be understood that the pitch 1340 is identical for both arrays 1300 and 1350.

However, array 1350 includes eight shutter assemblies 1352, arranged in a diamond layout as opposed to the sixteen shutter assemblies arranged into the grid pattern of array 1300. Each shutter assembly 1352 has about twice the surface area of the shutter assemblies 1302 in array 1300. As can be seen, the shutter assemblies 1352 are sized to fit two linearly adjacent shutter assemblies 1352 in the space defined by four adjacent control lines 1312. For example, FIG. 13 shows that shutter assembly 1352b extends between two adjacent control lines 1312. As such, two adjacent shutter assemblies, such as shutter assemblies 1352b and 1352d, will extend across the width of four control lines 1312. As noted with reference to array 1300, the width of four control lines will be some known distance measured in microns, inches or some unit of length, and this yields the density of control lines per unit length.

In contrast to array 1350, array 1300 fits four linearly adjacent shutter assemblies 1302 in the space defined by four adjacent control lines 1312, and each shutter assembly 1302 has a smaller aperture and smaller surface area. The larger surface area of the assembly 1352 allows for a larger relative aperture and therefore a larger aperture ratio. The above describes a benefit in resolution or pixels per inch (PPI) of the diamond layout array 1350. The diamond layout array 1350 can be implemented in a different manner to generate higher aperture ratio. The array 1350 keeps the line density substantially the same as that of square layout 1300. However, the pixel size is about two times larger than that of square layout 1300. The larger pixel will result in a larger aperture and a larger aperture ratio for the diamond layout array 1350.

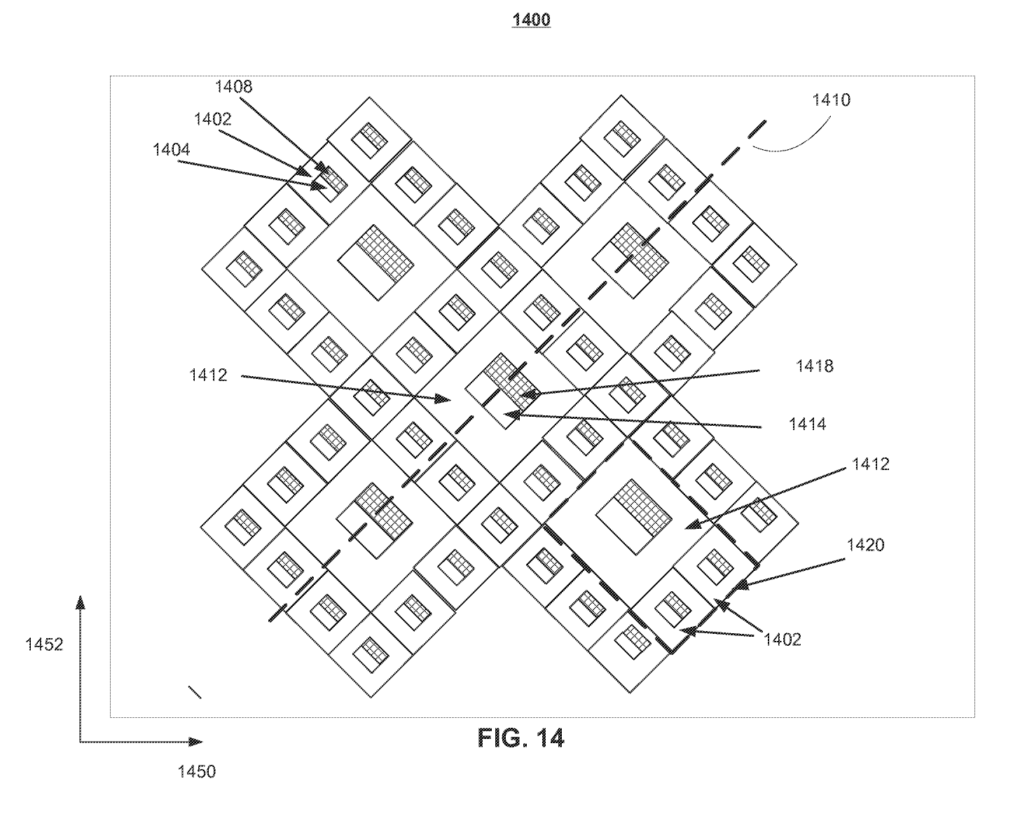

FIG. 14 is a plan view of an array of shutter assemblies having shutter assemblies of different sizes. In particular, FIG. 14 depicts a first array 1400 that includes a diamond pixel layout of shutter assemblies, including shutter assemblies 1402, having a first size, and shutter assemblies 1412 having a second larger size. As illustrated in FIG. 14, the shutter assemblies 1402 and the shutter assemblies 1412 are oriented to have the shutters 1404 and 1414 in the shutter assemblies 1402 and 1412 move along an axis of motion 1410. The axis of motion 1410 is traverse to the vertical axis 1452 of the array 1400 and the horizontal axis 1450 of the array 1400. In the depicted implementation, the shutter assembly 1412 has an area that is about four times larger than the area of the shutter assembly 1402. The shutter assembly 1412 has a shutter 1414 and an aperture 1418, both of which are about four times larger than the counterpart shutter 1404 and aperture 1408 of the smaller shutter assembly 1402. In other implementations, the relative sizes of the different shutter assemblies may vary, and the sizes selected will depend in part on the application being addressed.

The depicted shutter assemblies 1402 and 1412 are arranged in four-by-four arrays, with four smaller shutter assemblies 1402 disposed about the periphery of one larger shutter assembly 1412. The shutter assemblies may be grouped into a logical pixel and one such grouping is depicted by the hash-line rectangle 1420 that surrounds three shutter assemblies, one large shutter assembly 1412 and two smaller shutter assemblies 1402. The three shutter assemblies that are grouped within the rectangle 1420 may provide one logical pixel element for a display that uses the array 1400.

The controller may address and control the three shutter assemblies within this logical pixel, and may control the shutters to achieve a grayscale effect. In one implementation, the controller controls the duration for which the shutter assemblies 1402 and 1412 are open or closed. As is generally know in the art, by modulating light passing through the shutter and by selectively weighting the relative periods of time that the shutters pass and then block light, a grayscale effect may be achieved. The controller can modulate separately the three shutter assemblies that have been grouped into a logical pixel. In the depicted implementation, the controller can employ the differing sizes of the shutter assemblies 1402 and 1412, and in particular, the different sizes of the apertures 1408 and 1418 within the shutter assemblies, to more efficiently produce a grayscale effect. The shutter assembly 1420 has a larger aperture 1418 and therefore can provide greater illumination when open than the smaller aperture 1408 of shutter assembly 1402. Further, the shutter assembly 1420 can provide this greater illumination by movement of a single shutter 1404, and therefore in some implementations, the controller can use fewer control bits to achieve this level of illumination as compared to having to control, for example, four smaller shutter assemblies 1402. This grouping of larger and smaller shutter assemblies 1402 and 1412 into logical pixels can reduce the number of control bits, and therefore the bandwidth employed, to achieve grayscale for the image.

Variations and modifications can be made to the implementations described above without substantially departing from the principles of the present application. Such variations and modifications are also intended to be included within the scope of the appended claims. Therefore, the forgoing implementations are to be considered in all respects illustrative, rather than limiting of the application.

1. A display, comprising:
a plurality of pixels having respective electromechanical shutter assemblies and being arranged in rows and columns over a grid having a horizontal axis parallel to a horizontal axis of the display,
wherein respective shutter assemblies have a shutter movable along an axis of motion, and the shutter assembly is aligned within the grid to have the axis of motion extend at an angle relative to the horizontal axis of the grid.

2. The display according to claim 1, wherein shutter assemblies of adjacent columns of the grid are spatially offset to be arranged in different rows of the grid.

3. The display according to claim 1, wherein centers of the shutter assemblies in adjacent columns are aligned along an angle substantially 45° relative to the horizontal axis.

4. The display according to claim 1, wherein a shutter assembly has a rectangular peripheral edge and a side of the edge is oriented along an angle substantially 45° angle relative to the horizontal axis of the grid.

5. The display according to claim 1, wherein the shutter moves along the axis of motion between a first and a second position.

6. The display according to claim 5, further including an aperture for passing light toward the shutter and wherein the first position spaces the shutter away from the aperture and the second position aligns the shutter with the aperture.

7. The display according to claim 6, the shutter having dimensions to have the shutter in the second position align with and extend past the aperture and to overlap a peripheral edge of the aperture, wherein the shutter overlaps the peripheral edge of the aperture along the axis of motion less than or equal to axes transverse to the axis of motion.

8. The display according to claim 1, further comprising
a control line for controlling operation of electromechanical shutters in a column, wherein the control line connects to the shutters of a first column and to the shutters in a second column being adjacent to the first column, to connect the shutters in the first and second columns to a common control line.

9. The display according to claim 1, further comprising a common control line for controlling operation of electromechanical shutters in a column, wherein the control line connects to shutters along an axis parallel to an axis extending through center locations of the shutters.

10. The display according to claim 1, wherein
the axes of motion of shutters in adjacent columns or in adjacent rows are transverse.

11. The display according to claim 1, further comprising
an aperture for passing light toward the shutter, wherein the shutter has a rectangular peripheral edge with a side of the peripheral edge being substantially perpendicular to the axis of motion, to move along the axis of motion and across the aperture, between a first and the second position.

12. The display according to claim 1, further including a display controller for logically grouping a plurality of electromechanical shutter assemblies and controlling the grouped electromechanical shutter assemblies as sub-pixels in a logical pixel.

13. The display according to claim 12, wherein the electromechanical shutter assemblies include a first group of electromechanical shutter assemblies having a first size and a second group of electromechanical shutter assemblies having a second different size.

14. The display according to claim 13, wherein each of the logically grouped electromechanical shutter assemblies includes at least one electromechanical shutter assembly of the first size and at least one electromechanical shutter assembly of the second size to provide a logical pixel.

15. The display according to claim 13, wherein the electromechanical shutter assemblies having the first size have a first surface area and the electromechanical shutter assemblies having the second size have a second surface area about four times larger than the first surface area.

16. The display according to claim 12, wherein the display controller further includes a grayscale controller for separately controlling respective ones of the grouped electromechanical shutter assemblies to generate a grayscale value for the logical pixel.

17. The display according to claim 12, wherein the display controller varies the electromechanical shutter assemblies to group into the logical pixel to change a location of the logical pixel within an array formed from the rows and columns of pixels.

18. The display according to claim 12, wherein the display controller further includes a spatial grayscale controller for separately controlling electromechanical shutter assemblies adjacent the logical pixel to provide spatial grayscale.

19. A method of manufacturing a display, comprising:
arranging a plurality of pixels having respective electromechanical shutter assemblies in rows and columns over a grid having a horizontal axis, respective shutter assemblies having a shutter movable along an axis of motion, and
arranging the pixels within the grid to align the axis of motion of a shutter in a shutter assembly to extend at an angle relative to the horizontal axis of the grid.

20. The method according to claim 19, further comprising:
spatially offsetting shutter assemblies of adjacent columns of the grid to be arranged in different rows of the grid.

21. The method of claim 19, wherein arranging the pixels includes arranging the centers of shutter assemblies in adjacent columns to be aligned along an angle substantially 45° relative to the horizontal axis.

22. The method according to claim 19, further comprising
connecting a common control line to the shutters of a first column and to the shutters in a second column adjacent to the first column.

23. The method according to claim 19, further comprising connecting shutters to a common control line extending along an axis perpendicular to the horizontal axis of the grid.

24. The method according to claim 19, further comprising
configuring the shutter to be movable along the axis of motion between a first and a second position, and
arranging the shutter assemblies within the grid to have the axes of movement of shutters in adjacent columns or rows be transverse.

25. The method according to claim 19, further comprising
providing the shutter with a rectangular peripheral edge,
providing an aperture for passing light toward the shutter, and
arranging a side of the peripheral edge to move substantially perpendicular to the axis of movement and across the aperture to substantially block light passed toward the shutter.

26. The method according to claim 19, further comprising
providing control lines extending generally along columns of the grid, and
selecting a size of shutter assembly to arrange two shutter assemblies within a space defined by four adjacent control lines and selecting a size of aperture of a shutter assembly to achieve a selected aperture ratio.

27. A method for displaying a grayscale image, comprising
providing a plurality of electromechanical shutter assemblies,
arranging the shutter assemblies in rows and columns over a grid having a horizontal axis, wherein the shutter assemblies of adjacent columns are offset to align centers of shutter assemblies in adjacent columns along an angle relative to the horizontal axis,
logically grouping a plurality of shutter assemblies, and
controlling the grouped shutter assemblies as sub-pixels in a logical pixel to generate a grayscale illumination.

28. The method of claim 27, further comprising
receiving a grayscale value for the logical pixel, and
separately controlling respective ones of the shutter assemblies within the logical pixel according to the grayscale value for the logical pixel.

29. The method of claim 27, further comprising varying the shutter assemblies to group into the logical pixel to change a location of the logical pixel within an array formed from the rows and columns of pixels.

30. The method of claim 27, further comprising separately controlling electromechanical shutters adjacent the logical pixel to provide dithered grayscale in an image.
